(19) United States
(12) Patent Application Publication
(10) Pub. No.: US 2025/0068496 A1
(43) Pub. Date: Feb. 27, 2025

(54) PROTECTION LEVEL CALCULATION DEVICE, PROTECTION LEVEL CALCULATION SYSTEM, POSITIONING SYSTEM, AND PROTECTION LEVEL CALCULATION METHOD

(71) Applicant: Mitsubishi Electric Corporation, Tokyo (JP)

(72) Inventors: Yuki SATO, Tokyo (JP); Akinori TAIRA, Tokyo (JP); Rui HIROKAWA, Tokyo (JP)

(73) Assignee: Mitsubishi Electric Corporation, Tokyo (JP)

(21) Appl. No.: 18/725,826

(22) PCT Filed: Jan. 6, 2022
(86) PCT No.: PCT/JP2022/000246

§ 371 Date: Jul. 1, 2024

(51) Int. Cl. G06F 11/07

(52) U.S. Cl. CPC G06F 11/0754

(57) ABSTRACT

A protection level calculation device includes a bias error model unit that outputs the upper limit and the lower limit of a bias error assumed to be contained in a measurement obtained from a positioning signal, and a protection level calculation unit that calculates a protection level for determining the validity of a positioning solution calculated based on the measurement, using the upper limit and the lower limit. The protection level calculation device can calculate the protection level effective for determining the validity of the positioning solution calculated from the measurement.

### FIELD

The present disclosure relates to a protection level calculation device, a protection level calculation system, a positioning system, and a protection level calculation method for calculating a protection level for determining the validity of a positioning solution.

### BACKGROUND

For advanced applications such as automatic driving, there are positioning systems that determine the position of an application using signals transmitted by positioning satellites of the Global Positioning System (GPS), wireless communication base stations, or the like. To allow the safe use of an application under the control of the application using a positioning solution calculated from measurements, such positioning systems determine whether or not the calculated positioning solution is valid, using a protection level.

For example, a protection level calculation device described in Patent Literature 1 derives in advance a multivariate probability distribution model including distance measurement error and measurement quality indicators of distance measurements. When performing positioning, the protection level calculation device described in Patent Literature 1 determines, for a measurement of the distance from each of a plurality of signal sources transmitting a positioning signal, the conditional probability density of a measurement error with respect to values of the measurement quality indicators obtained at the same time, and calculates the protection level of a positioning solution from the relationship between the measurement errors and a positioning error.

### CITATION LIST

### Patent Literature

Patent Literature 1: Japanese Patent No. 6855580

### SUMMARY OF INVENTION

### Problem to be Solved by the Invention

According to the conventional technique disclosed in Patent Literature 1, when an anomalous measurement is included at the time of use of the multivariate probability distribution model, the protection level calculation device rejects the anomalous measurement to calculate the protection level. Therefore, the conventional technique has a problem that the protection level calculation device cannot calculate the effective protection level if it fails to reject an anomalous measurement.

The present disclosure has been made in view of the above, and an object thereof is to provide a protection level calculation device capable of calculating a protection level effective for determining the validity of a positioning solution calculated from measurements.

### Means to Solve the Problem

In order to solve the above-described problems and achieve the object, a protection level calculation device according to the present disclosure includes: a bias error model unit to output an upper limit and a lower limit of a bias error assumed to be contained in a measurement obtained from a positioning signal; and a protection level calculation unit to calculate a protection level for determining validity of a positioning solution calculated based on the measurement, using the upper limit and the lower limit.

### Effects of the Invention

The protection level calculation device according to the present disclosure has the effect of being able to calculate the protection level effective for determining the validity of the positioning solution calculated from the measurements.

### BRIEF DESCRIPTION OF DRAWINGS

FIG. 1 is a diagram illustrating a configuration example of a positioning system according to a first embodiment.

FIG. 2 is a diagram illustrating a configuration example of a protection level calculation system included in the positioning system according to the first embodiment.

FIG. 3 is a diagram illustrating a configuration example of a control circuit according to the first embodiment.

FIG. 4 is a diagram illustrating a configuration example of a dedicated hardware circuit according to the first embodiment.

FIG. 5 is a flowchart illustrating an operation procedure for the protection level calculation system included in the positioning system according to the first embodiment.

FIG. 6 is a diagram for explaining a noncentrality parameter used in the calculation of a protection level in the first embodiment.

FIG. 7 is a diagram illustrating an example of arrangement of satellites for explaining a procedure to calculate a horizontal protection level in the first embodiment.

FIG. 8 is a diagram illustrating a first modification of the protection level calculation system in the first embodiment.

FIG. 9 is a diagram illustrating a second modification of the protection level calculation system in the first embodiment.

FIG. 10 is a diagram illustrating a third modification of the protection level calculation system in the first embodiment.

FIG. 11 is a diagram illustrating a fourth modification of the protection level calculation system in the first embodiment.

FIG. 12 is a diagram illustrating a configuration example of a positioning system according to a second embodiment.

FIG. 13 is a diagram illustrating a configuration example of a protection level calculation system included in the positioning system according to the second embodiment.

FIG. 14 is a diagram illustrating a configuration example of a protection level calculation system included in a positioning system according to a third embodiment.

FIG. 15 is a diagram illustrating an example of models of the upper limit and the lower limit of a bias error used by the protection level calculation system of the third embodiment.

FIG. 16 is a diagram illustrating a modification of the protection level calculation system included in the positioning system according to the third embodiment.

FIG. 17 is a diagram illustrating a configuration example of a protection level calculation system included in a positioning system according to a fourth embodiment.

### DESCRIPTION OF EMBODIMENTS

Hereinafter, a protection level calculation device, a protection level calculation system, a positioning system, and a protection level calculation method according to embodiments will be described in detail with reference to the drawings.

### First Embodiment

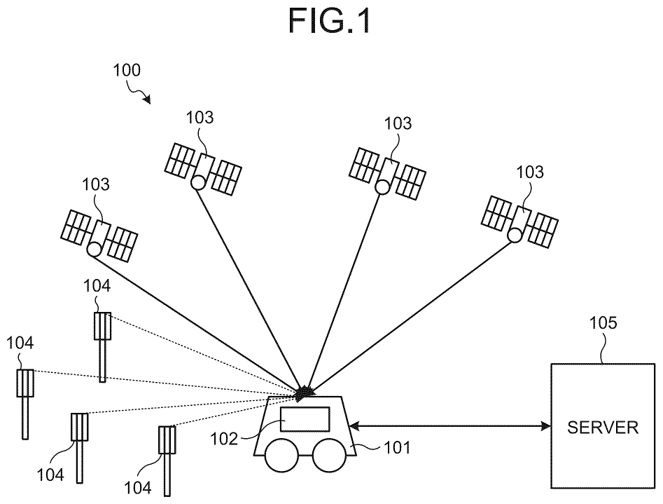

FIG. 1 is a diagram illustrating a configuration example of a positioning system 100 according to a first embodiment. The positioning system 100 includes an application 101 that is an object of positioning, a positioning terminal 102 installed in the application 101, a plurality of satellites 103 that are positioning satellites, base stations 104 for wireless communication, and a server 105 connected to the base stations 104 via a communication network. The positioning satellites are, for example, GPS satellites used in GPS or quasi-zenith satellites used in the Quasi-Zenith Satellite System (QZSS). In the example illustrated in FIG. 1, the application 101 is a vehicle. The positioning terminal 102 can communicate with the base stations 104 by wireless communication, and with the server 105 via a communication network.

The satellites 103 transmit positioning signals. The positioning terminal 102 receives the positioning signals and determines the position of the application 101. Instead of the satellites 103, the base stations 104 may transmit positioning signals to the positioning terminal 102. That is, signal sources of the positioning signals may be either the satellites 103 or the base stations 104.

When receiving the positioning signals from the signal sources, the positioning terminal 102 extracts information on the positions of the signal sources and information on the distances between the application 101 and the signal sources as measurements. The positioning terminal 102 calculates the positioning solution of the application 101 by positioning calculation using the measurements. That is, the positioning terminal 102 performs positioning calculation. The positioning solution includes information on the horizontal position and information on the vertical position.

The measurements extracted using the positioning signals include errors. The errors in the measurements when the satellites 103 are the signal sources include, for example, errors due to the satellites 103 such as satellite clock errors or satellite orbit errors, errors due to the atmosphere such as ionospheric delays or tropospheric delays, errors due to a reception environment such as multipath errors or radio wave interferences, and errors due to a receiver such as a receiver clock error or receiver inter-signal biases.

Therefore, the positioning terminal 102 uses a protection level to determine the validity of the calculated positioning solution. The positioning terminal 102 calculates the protection level, using an observation model corresponding to the measurements used in the positioning calculation and weights in the positioning calculation. That is, the positioning terminal 102 computes the protection level. A specific method of calculating the protection level will be described later.

In the positioning system 100, a limit value indicating the limit of a positioning error within which the application 101 can effectively use the positioning solution calculated by the positioning terminal 102 is set. The limit value is called an alert limit and is predetermined by the application 101. The positioning terminal 102 compares the calculated protection level with the limit value to determine the validity of the calculated positioning solution. Based on the result of determining the validity of the calculated positioning solution, the positioning terminal 102 determines whether or not the calculated positioning solution can be used. That is, the positioning terminal 102 determines whether or not the calculated positioning solution can be used.

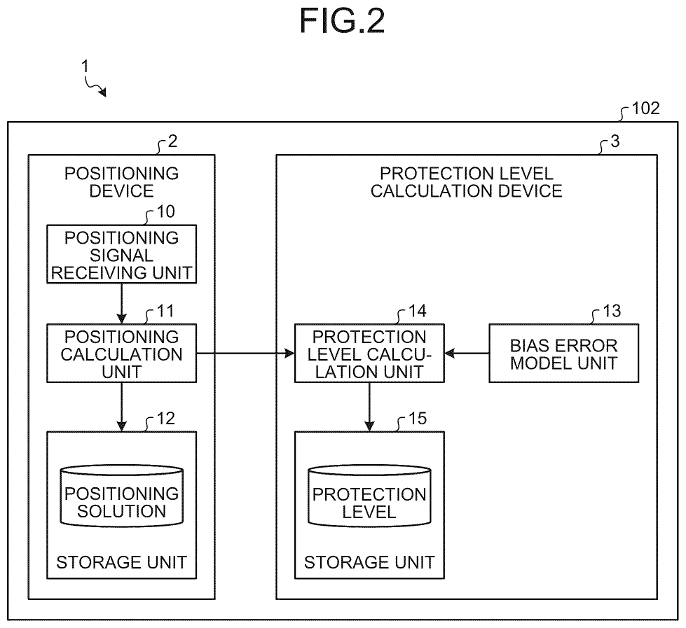

The positioning system 100 includes a protection level calculation system that calculates the protection level. Here, a configuration of the protection level calculation system will be described. FIG. 2 is a diagram illustrating a configuration example of a protection level calculation system 1 included in the positioning system 100 according to the first embodiment. The protection level calculation system 1 illustrated in FIG. 2 includes a positioning device 2 that performs positioning and a protection level calculation device 3 that calculates the protection level.

Here, a description is given of a case where both the positioning device 2 and the protection level calculation device 3 are incorporated in the positioning terminal 102 illustrated in FIG. 1. Note that, as described later, the positioning device 2 may be incorporated in the positioning terminal 102, and the protection level calculation device 3 may be incorporated in a server 105 or the like that is a device outside the positioning terminal 102. Alternatively, both the positioning device 2 and the protection level calculation device 3 may be incorporated in an external device such as the server 105. When the positioning device 2 is incorporated in a device other than the positioning terminal 102, a positioning signal receiving unit 10 described below is included in the positioning device 2.

The positioning device 2 includes the positioning signal receiving unit 10 that receives the positioning signals transmitted by the signal sources, a positioning calculation unit 11 that performs positioning calculation, and a storage unit 12 that stores information. The positioning signal receiving unit 10 includes an antenna and a receiver. The antenna and the receiver are not illustrated. The storage unit 12 stores the positioning solution calculated by the positioning calculation unit 11.

The protection level calculation device 3 includes a bias error model unit 13 that outputs the upper limit and the lower limit of bias errors assumed to be contained in measurements obtained from the positioning signals, a protection level calculation unit 14 that calculates the protection level of the positioning solution, and a storage unit 15 that stores information. The protection level calculation unit 14 calculates the protection level for determining the validity of the positioning solution calculated based on the measurements, using the upper limit and the lower limit output by the bias error model unit 13. The storage unit 15 stores the calculated protection level. The upper limit and the lower limit of the bias errors can be included, for example, in information called integrity assistance data in the standard defined by the standards group 3rd Generation Partnership Project (3GPP). The integrity assistance data including the upper limit and the lower limit is transmitted from the bias error model unit 13 to the protection level calculation unit 14. In the example illustrated in FIG. 2, the positioning calculation unit 11, the bias error model unit 13, and the protection level calculation unit 14 are incorporated in the positioning terminal 102.

When receiving the positioning signals, the positioning signal receiving unit 10 extracts information on the positions of the signal sources and information on the distances between the application 101 and the signal sources as measurements. The positioning signal receiving unit 10 outputs the measurements to the positioning calculation unit 11. The measurements output by the positioning signal receiving unit 10 may include carrier-phase measurements, Doppler frequency measurements, or the like.

The positioning calculation unit 11 calculates the positioning solution using the input measurements. In addition to the positioning solution, the positioning calculation unit 11 outputs pieces of information on the observation model corresponding to the measurements from the signal sources used in the positioning calculation and the weights in the positioning calculation. The positioning solution calculated by the positioning calculation unit 11 may include information on speed, acceleration, or the like.

The positioning device 2 sends the positioning solution, the observation model, and the weights in the positioning calculation output from the positioning calculation unit 11 to the protection level calculation device 3. The pieces of information on the positioning solution, the observation model, and the weights in the positioning calculation are input to the protection level calculation unit 14. The upper limit and the lower limit of the bias errors output from the bias error model unit 13 are input to the protection level calculation unit 14. The protection level calculation unit 14 calculates the protection level of the positioning solution, using the observation model and the weights in the positioning calculation, and the upper limit and the lower limit of the bias errors. The protection level calculated by the protection level calculation unit 14 is stored in the storage unit 15.

Here, a hardware configuration for implementing the positioning device 2 and the protection level calculation device 3 will be described. As described above, the positioning signal receiving unit 10 of the positioning device 2 includes the antenna and the receiver. Of the components of the positioning device 2 illustrated in FIG. 2, the positioning calculation unit 11 is implemented by a processing circuit. Part of the positioning signal receiving unit 10 may be a processing circuit. These processing circuits may be a circuit in which a processor executes software, or may be a dedicated circuit.

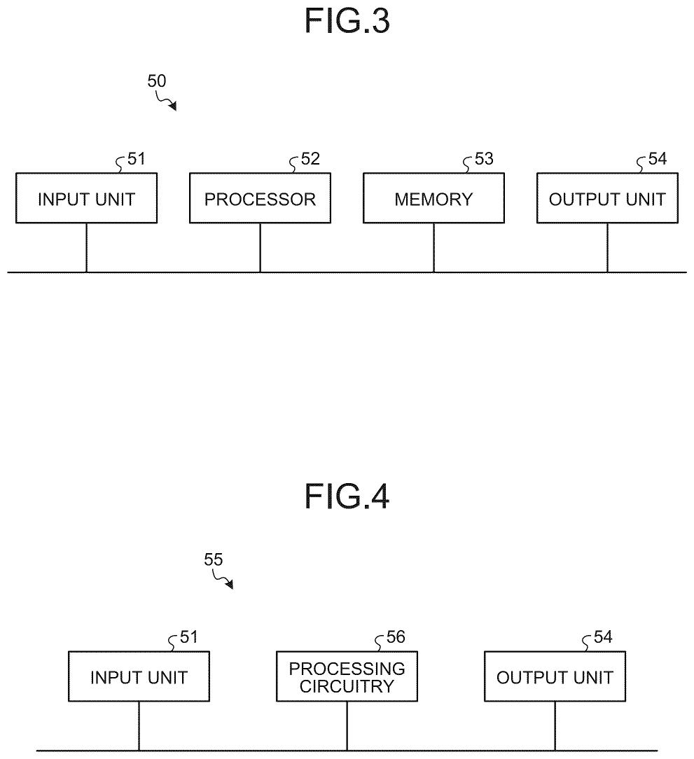

When the processing circuit is implemented by software, the processing circuit is, for example, a control circuit illustrated in FIG. 3. FIG. 3 is a diagram illustrating a configuration example of a control circuit 50 according to the first embodiment. The control circuit 50 includes an input unit 51, a processor 52, a memory 53, and an output unit 54.

The input unit 51 is an interface circuit that receives data input from the outside of the control circuit 50 and provides the data to the processor 52. The output unit 54 is an interface circuit that sends data from the processor 52 or the memory 53 to the outside of the control circuit 50. When the processing circuit is the control circuit 50 illustrated in FIG. 3, the processor 52 reads and executes a program corresponding to each component of the positioning device 2 stored in the memory 53, thereby implementing each component. The processor 52 outputs data such as calculation results to a volatile memory of the memory 53. The memory 53 is also used as a temporary memory in each process performed by the processor 52. The processor 52 may output data such as calculation results to the memory 53 and store the data in the memory 53, or may store data such as calculation results in an auxiliary storage device via the volatile memory of the memory 53. The storage unit 12 is implemented by the memory 53 or the auxiliary storage device. The illustration of the auxiliary storage device is omitted.

The processor 52 is a central processing unit (CPU, also called a central processor, a processing device, an arithmetic device, a microprocessor, a microcomputer, a processor, or a digital signal processor (DSP)). The memory 53 corresponds, for example, to nonvolatile or volatile semiconductor memory such as random-access memory (RAM), read-only memory (ROM), flash memory, an erasable programmable read-only memory (EPROM), or an electrically erasable programmable read-only memory (EEPROM) (registered trademark), or a magnetic disk, a flexible disk, an optical disk, a compact disc, a mini disc, a digital versatile disc (DVD), or the like.

Of the components of the protection level calculation device 3 illustrated in FIG. 2, the bias error model unit 13 and the protection level calculation unit 14 are implemented by the control circuit 50 as described above. The storage unit 15 is implemented by the memory 53 or the auxiliary storage device.

FIG. 3 is an example of hardware when the positioning calculation unit 11, the bias error model unit 13, and the protection level calculation unit 14 are implemented by the general-purpose processor 52 and the memory 53. However, the positioning calculation unit 11, the bias error model unit 13, and the protection level calculation unit 14 may be implemented by a dedicated hardware circuit. FIG. 4 is a diagram illustrating a configuration example of a dedicated hardware circuit 55 according to the first embodiment.

The dedicated hardware circuit 55 includes the input unit 51, the output unit 54, and processing circuitry 56. The processing circuitry 56 is a single circuit, a combined circuit, a programmed processor, a parallel-programmed processor, an application-specific integrated circuit (ASIC), a field-programmable gate array (FPGA), or a circuit combining them. Note that the positioning calculation unit 11, the bias error model unit 13, and the protection level calculation unit 14 may be implemented by combining the control circuit 50 and the hardware circuit 55.

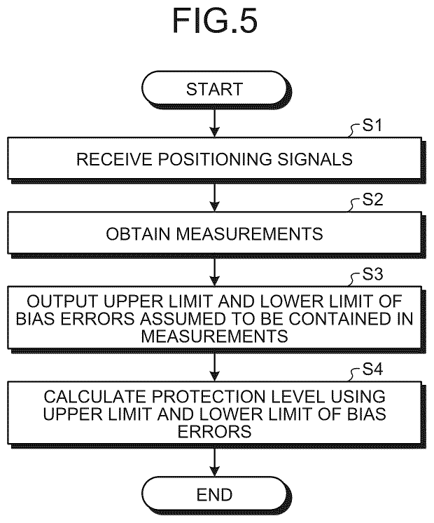

Next, an operation procedure for the protection level calculation system 1 of the first embodiment will be described. FIG. 5 is a flowchart illustrating the operation procedure for the protection level calculation system 1 included in the positioning system 100 according to the first embodiment. Here, an operation procedure for calculating the protection level by the protection level calculation system 1 will be described.

In step S1, the protection level calculation system 1 receives the positioning signals at the positioning signal receiving unit 10 of the positioning device 2. When receiving the positioning signals, in step S2, the protection level calculation system 1 obtains measurements by extracting the measurements from the positioning signals at the positioning signal receiving unit 10. The positioning signal receiving unit 10 extracts information on the positions of the signal sources and information on the distances between the application 101 and the signal sources as measurements.

In step S3, the bias error model unit 13 of the protection level calculation device 3 outputs the upper limit and the lower limit of bias errors assumed to be contained in the measurements. In step S4, the protection level calculation unit 14 of the protection level calculation device 3 calculates the protection level using the upper limit and the lower limit of the bias errors. The calculated protection level is stored in the storage unit 15. Thus, the protection level calculation system 1 completes the operation according to the procedure illustrated in FIG. 5.

Next, a method of calculating the protection level in the first embodiment will be described. The positioning calculation unit 11 outputs a coefficient matrix H∈R^{m×n} as an observation model corresponding to measurements y∈R^{m} from each signal source used in the positioning calculation. The coefficient matrix H∈R^{m×n} is obtained by linearizing a nonlinear observation model h(x)∈R^{m} for the measurements based on state quantities x∈Rⁿ around state quantities x₀∈Rⁿ serving as a reference. The state quantities x∈R^{m} include three-dimensional position information indicating the three-dimensional position of the positioning terminal 102.

In addition, the positioning calculation unit 11 outputs an error covariance matrix R∈R^{m×m} of observation errors as weights in the positioning calculation. The positioning calculation unit 11 may output, as the weights in the positioning calculation, a positive definite symmetric matrix W in which the sum of eigenvalues is m, together with the variance α₀² of the observation errors with respect to the unit weight. In this case, the error covariance matrix R of the observation errors is determined from the relationship W=α₀²R⁻¹. Here, m represents the number of dimensions of the measurements used in the positioning calculation. n represents the number of dimensions of the state quantities estimated by the positioning calculation.

The bias error model unit 13 outputs the upper limit bₘₐₓ∈R^{m} of a bias error and the lower limit bₘᵢₙ∈R^{m} of the bias error. This bias error is a bias error assumed to be contained in each measurement used in the positioning calculation, and varies from measurement to measurement.

The protection level calculation unit 14 calculates the horizontal protection level HPL, using the observation model and the weights in the positioning calculation input from the positioning calculation unit 11, and the upper limit and the lower limit of the bias errors input from the bias error model unit 13. The horizontal protection level HPL is obtained by solving a nonlinear programming problem shown in (1) below for a bias vector b∈R^{m}. The nonlinear programming problem shown in (1) can be solved by a general nonlinear programming solver.

$$\begin{matrix}Formula 1 & \\ Maximize \\ HPL = \sqrt{{( {M}_{1} b )}^{2} + {( {M}_{2} b )}^{2}} \\ Subject to \\ {b}^{T} Gb \leq λ \\ {b}_{i , min} \leq {b}_{i} \leq {b}_{i , max} ( i = 1 , … , m ) & ( 1 )\end{matrix}$$

Here, differential coefficients related to the positions that are differential coefficients included in the coefficient matrix H are expressed in a local horizontal coordinate system based on a three-dimensional position given by the state quantities x₀ serving as a reference. The local horizontal coordinate system is also called an east-north-up (ENU) coordinate system. When the coordinate transformation of the differential coefficients is required, the positioning calculation unit 11 or the protection level calculation unit 14 performs the coordinate transformation.

In the nonlinear programming problem shown in (1), M₁∈R^{1×m} is a row related to a position component in the east-west direction with respect to the reference three-dimensional position in a matrix M=(H^{T}R⁻¹H)⁻¹H^{T}R⁻¹∈R^{n×m}. M₂∈R^{1×m} is a row related to a position component in the north-south direction with respect to the reference three-dimensional position in the matrix M=(H^{T}R⁻¹H)⁻¹H^{T}R⁻¹∈R^{n×m}. A matrix G∈R^{1×m} is expressed as G=(R⁻¹−R⁻¹H(H^{T}R⁻¹H)⁻¹H^{T}R⁻¹). b_{i,min} and b_{i,max} are elements of bₘᵢₙ and bₘₐₓ. i is a measurement index. A is a noncentrality parameter determined from a false alarm rate, a non-detection rate, and the degree of freedom m−n in the determination of whether or not the positioning solution can be used. The false alarm rate is the probability of determining that the positioning solution cannot be used although it can be used. The non-detection rate is the probability of determining that the positioning solution can be used although it should not be used. The value of the noncentrality parameter λ is stored in the memory 53 or the like, for example, by creating a table in which the value of the noncentrality parameter λ is associated with the value of the degree of freedom, with the false alarm rate and the non-detection rate as fixed values. Alternatively, the value of the noncentrality parameter λ may be obtained by calculation each time the false alarm rate and the non-detection rate are changed according to a change in the surrounding environment in which the positioning is performed.

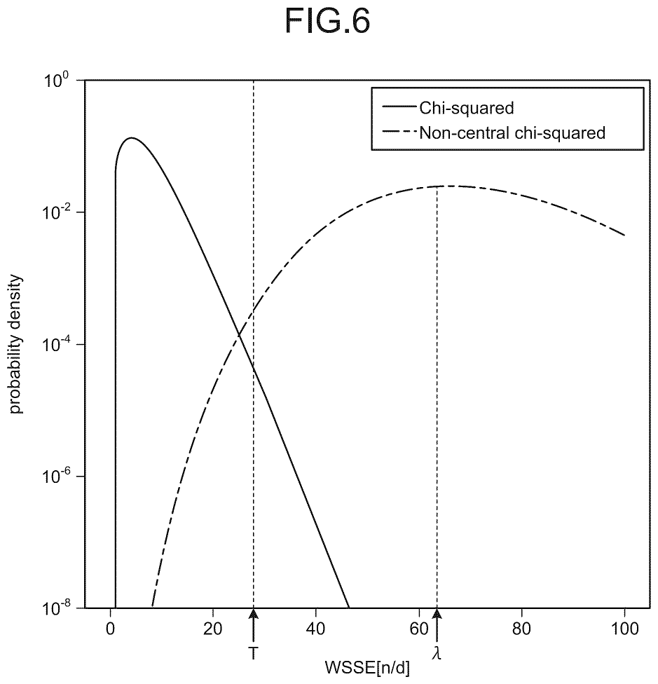

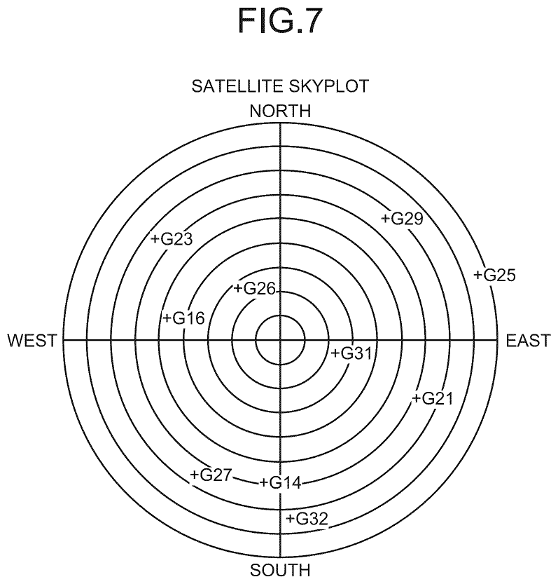

Next, the noncentrality parameter λ will be described with reference to FIG. 6. FIG. 6 is a diagram for explaining the noncentrality parameter used in the calculation of the protection level in the first embodiment. The horizontal axis of a graph illustrated in FIG. 6 represents a test statistic of the positioning solution. The vertical axis of the graph illustrated in FIG. 6 represents the probability density of the test statistic of the positioning solution. Here, as the test statistic, the weighted sum squared error (WSSE) of observation residuals of the positioning solution is used. The WSSE of the observation residuals of a positioning solution x∈R is expressed as WSSE=(y−h(x\hat{ }))^{T}R⁻¹(y−h(x\hat{ })). When all the measurements are normal, the test statistic follows the chi-squared distribution. When one or more of the measurements are anomalous, the test statistic follows the non-central chi-squared distribution. When the value of the test statistic exceeds a threshold T determined from the false alarm rate, the positioning terminal 102 determines that the positioning solution cannot be used without calculating the protection level. When the test statistic is less than or equal to the threshold T, the positioning terminal 102 calculates the protection level and determines whether or not the positioning solution can be used by comparison with the alert limit. The positioning terminal 102 determines the validity of the positioning solution by determining whether or not the positioning solution can be used.

Here, as an example, assume that the false alarm rate is 10⁻⁴, the non-detection rate is 10⁻³, and the degree of freedom is 6. In this example, the value of the noncentrality parameter λ is about 63.632324. The false alarm rate is a value obtained by integrating the density function of the chi-squared distribution with 6 degrees of freedom from the threshold T to infinity. The non-detection rate is a value obtained by integrating the density function of the non-central chi-squared distribution with 6 degrees of freedom from 0 to the threshold T. FIG. 6 illustrates the chi-squared distribution curve and the non-central chi-squared distribution curve. First, the threshold T at which the false alarm rate becomes a given value is numerically determined. Subsequently, the noncentrality parameter λ is obtained by numerically determining the noncentrality parameter of the non-central chi-squared distribution at which the non-detection rate becomes a given value.

As with the calculation of the horizontal protection level HPL, the protection level calculation unit 14 calculates the vertical protection level VPL, using the observation model and the weights in the positioning calculation input from the positioning calculation unit 11, and the upper limit and the lower limit of the bias errors input from the bias error model unit 13. The vertical protection level VPL is obtained by solving a nonlinear programming problem shown in (2) below for a bias vector b∈R^{m}. The nonlinear programming problem shown in (2) can be solved by a general nonlinear programming solver.

$$\begin{matrix}Formula 2 & \\ Maximize \\ VPL = {M}_{3} b \\ Subject to \\ {b}^{T} Gb \leq λ \\ {b}_{i , min} \leq {b}_{i} \leq {b}_{i , max} ( i = 1 , … , m ) & ( 2 )\end{matrix}$$

In the nonlinear programming problem shown in (2), M₃εR^{1×m} is a row related to a position component in the up-and-down direction with respect to the reference three-dimensional position in the matrix M.

Next, a specific procedure to calculate the horizontal protection level HPL will be described with reference to FIG. 7. FIG. 7 is a diagram illustrating an example of arrangement of the satellites 103 for explaining the procedure to calculate the horizontal protection level in the first embodiment. FIG. 7 illustrates a sky plot diagram showing the positions of ten GPS satellites on the celestial sphere. G14, G16, G21, G23, G25, G26, G27, G29, G31, and G32 illustrated in FIG. 7 represent the satellites 103. Here, assume that the positioning calculation unit 11 uses only one-frequency pseudo-range measurements at a point where the positioning is performed, of signals transmitted from the ten GPS satellites. That is, m=10. As state quantities, the positioning calculation unit 11 uses only three-dimensional position information and a receiver clock offset. That is, n=4. Thus, the protection level calculation unit 14 calculates the protection level, using an observation model for the four state quantities on the ten measurements, the weights in the positioning calculation, and the upper limit and the lower limit of the bias errors. A coefficient matrix H∈R^{10×4} linearized around an approximate position determined approximately is expressed in an ENU coordinate system, which is a local horizontal coordinate system, as in equation (3) below. Note that in each numerical value included on the right side of equation (3), five decimal places and beyond are omitted.

$$\begin{matrix}Formula 3 & \\ H = [ \begin{matrix}- 0.0789 & - 0.8534 & 0.5152 & 1. \\ - 0.6905 & 0.1399 & 0.7096 & 1. \\ 0.8252 & - 0.334 & 0.4554 & 1. \\ - 0.7086 & 0.5951 & 0.3791 & 1. \\ 0.9464 & 0.3145 & 0.0737 & 1. \\ - 0.2202 & 0.3507 & 0.9102 & 1. \\ - 0.4585 & - 0.7862 & 0.4143 & 1. \\ 0.6097 & 0.6741 & 0.4169 & 1. \\ 0.3806 & - 0.065 & 0.9225 & 1. \\ 0.0694 & - 0.9689 & 0.2374 & 1.\end{matrix} ] & ( 3 )\end{matrix}$$

The coefficient matrix H represents the observation model. The rows of the coefficient matrix H correspond to the respective GPS satellites. In each row of the matrix shown in (3), values of an east-west direction vector, a north-south direction vector, and an up-and-down direction vector, and a coefficient of the receiver clock offset are shown in order from the left.

When the variance of the observation errors is σ′=1.0 [m²] regardless of the elevation angles of the satellites 103, a covariance matrix R∈R^{10×10} of the observation errors is a diagonal matrix σ²I¹⁰ with σ²=1.0 as a diagonal element. The covariance matrix R∈R^{10×10} represents weights in the positioning calculation. However, at this time, Iₘ is an identity matrix of m×m. From the coefficient matrix H and the covariance matrix R of the observation errors, M₁∈R^{1×10}, M₁∈R^{1×10}, and G∈R^{10×10} are expressed by equations (4), (5), and (6), respectively. Note that in each numerical value included on the right side of equation (4), each numerical value included on the right side of equation (5), and each numerical value included on the right side of equation (6), five decimal places and beyond are omitted.

$$\begin{matrix}Formula 4 & \\ {M}_{1} = [ - 0.017 - 0.2166 0.2558 - \text{} 0.3222 0.1775 - 0.0152 - 0.1739 0.1332 0.2088 - 0.0304 ] & ( 4 )\end{matrix}$$

$${M}_{2} = [ - 0.2296 0.0762 - \text{} 0.098 0.2578 0.144 0.0978 - 0.1815 0.2255 - 0.0553 - 0.2367 ] \qquad ( 5 )$$

$$G = [ \begin{matrix}\begin{matrix}0.7221 - 0.0754 - 0.1386 0.0545 0.042 \\ - 0.0346 - 0.2611 0.0922 - 0.1207 - 0.2803\end{matrix} \\ ⋮ \\ ⋮ \\ \begin{matrix}- 0.2803 0.0027 - 0.1504 - 0.0032 - 0.1239 \\ 0.1356 - 0.3105 0.0685 0.0597 0.6017\end{matrix}\end{matrix} ] \qquad ( 6 )$$

When the false alarm rate is 10⁻⁴ and the non-detection rate is 10⁻³, the degree of freedom is m−n=6, which is the same as the value of the degree of freedom described above. Therefore, the value of the noncentrality parameter λ is also the same as the above-described value. For example, when the minimum value of the bias errors is 0 [m] and the maximum value is 10 [m] for all the measurements, bₘᵢₙ and bₘₐₓ are expressed by equations (7) and (8) below, respectively.

$$\begin{matrix}Formula 5 & \\ \text{?} = [ 0. 0. 0. 0. 0. 0. 0. 0. 0. 0. ] & ( 7 )\end{matrix}$$

$${b}_{max} = [ 10. 10. 10. 10. 10. 10. 10. 10. 10. 10. ] \qquad ( 8 )$$

$$\text{?} \text{indicates text missing or illegible when filed}$$

When the nonlinear programming problem shown in (1) above is solved for a bias vector b∈R¹⁰, using these values, the bias vector b is expressed by equation (9) below. Note that in each numerical value included on the right side of equation (9), five decimal places and beyond are omitted.

$$Formula 6$$

$$( 9 )$$

$$\begin{matrix}0. & 10. & 0. & 10. & 0. & 10. & 8.5466 & 10. & 0. & 0.\end{matrix} ]$$

At this time, the horizontal protection level HPL is 7.591439 [m].

Here, the example of calculation of the horizontal protection level HPL using only GPS satellites has been described, but the positioning system 100 may calculate the horizontal protection level HPL using Galileo satellites or quasi-zenith satellites. In such a case, the positioning system 100 can add an inter-satellite system bias of the receiver to the state quantities, according to the types of the satellites 103 used.

Here, the example of calculation of the horizontal protection level HPL using only one-frequency pseudo-range measurements has been described, but the positioning system 100 may calculate the horizontal protection level HPL using two or more frequencies. In such a case, the positioning system 100 can add an inter-frequency bias of the receiver to the state quantities, according to the number of frequencies used.

Furthermore, a reference satellite may be determined for each satellite system, and a measurement based on a signal from each satellite 103 may be a single difference value with respect to the reference satellite. In such a case, the positioning system 100 can remove the receiver clock offset, and the inter-satellite system bias and the inter-frequency bias of the receiver from the state quantities.

Here, the example of calculation of the horizontal protection level HPL using pseudo-range measurements has been described, but carrier-phase measurements may be added. In such a case, the positioning system 100 can add the carrier-phase ambiguity to the state quantities. Furthermore, the speed or acceleration of the receiver may be added to the state quantities.

In the example of calculation of the horizontal protection level HPL, the minimum value and the maximum value of the bias errors are common to all the measurements, but the minimum value and the maximum value of the bias errors may be changed on a measurement by measurement basis. Furthermore, as the minimum value of the bias errors, a value other than zero or a negative value may be given. As the maximum value of the bias errors, zero or a negative value may be given.

In the example of calculation of the horizontal protection level HPL, the satellites 103 are used as the signal sources of the positioning signals, but the signal sources may be either the satellites 103 or the base stations 104. The signal sources may be a combination of the satellites 103 and the base stations 104.

The positioning calculation unit 11 may calculate the positioning solution by observation update with the Kalman filter or the like using prior prediction values xₚᵣₑ∈Rⁿ of the state quantities. The protection level calculation unit 14 calculates the protection level, further using the weights of the prior prediction values of the state quantities, which are the weights used in the calculation of the positioning solution, and the upper limit and the lower limit of bias errors assumed to be contained in the prior prediction values. In this case, each of the positioning calculation unit 11, the bias error model unit 13, and the protection level calculation unit 14 is extended as follows.

The positioning calculation unit 11 outputs a coefficient matrix H∈R^{m×n}, as an observation model corresponding to measurements y∈R^{m} from each signal source used in the positioning calculation. The positioning calculation unit 11 outputs the error covariance matrix RE R^{m×m} of observation errors as the weights in the positioning calculation. In addition, the positioning calculation unit 11 outputs an error covariance matrix Q∈R^{n×n} as the weights of prior prediction values of the state quantities. As in the case described above, the positioning calculation unit 11 may output, as the weights in the positioning calculation, the positive definite symmetric matrix W in which the sum of eigenvalues is m, together with the variance σ₀² of the observation errors with respect to the unit weight. In this case, the error covariance matrix R of the observation errors is determined from the relationship W=σ₀²R⁻¹. Here, m represents the number of dimensions of the measurements used in the positioning calculation. n represents the number of dimensions of the state quantities estimated by the positioning calculation. As the test statistic of the positioning solution, WSSE=(y−h(xₚᵣₑ))^{T}(HQH+R)⁻¹(y−h(xₚᵣₑ)) is used.

Furthermore, the positioning calculation unit 11 may calculate prior prediction values of the state quantities and the error covariance matrix Q, using a measurement of an inertial sensor such as an accelerometer or a gyroscope. In particular, when the time intervals at which the signal sources can be used are long, using a measurement of the inertial sensor can prevent increases in errors in prior prediction values due to the lapse of time. In this case, the values of the error covariance matrix Q also decrease, and the weights of the prior prediction values of the state quantities increase. Moreover, when a measurement of the inertial sensor is used, the upper limit and the lower limit can be set such that the bias errors assumed to be contained in the prior prediction values decrease. As a result, the value of the protection level decreases.

The bias error model unit 13 outputs the upper limit and the lower limit of the bias error assumed to be contained in each measurement used in the positioning calculation, and the upper limit and the lower limit of the bias errors assumed to be contained in the prior state quantities. At this time, the upper limit bₘₐₓ of the two types of bias errors is bₘₐₓ∈R^{m+n}. The lower limit bₘᵢₙ of the two types of bias errors is bₘᵢₙ∈R^{m+n}.

The protection level calculation unit 14 calculates the horizontal protection level HPL, using the observation model, the weights in the positioning calculation, and the weights of the prior prediction values of the state quantities input from the positioning calculation unit 11, and the upper limit and the lower limit of the bias errors input from the bias error model unit 13. The horizontal protection level HPL is obtained by solving a nonlinear programming problem shown in (10) below for a bias vector b∈R^{m+n}. The nonlinear programming problem shown in (10) can be solved by a general nonlinear programming solver.

$$Formula 7$$

$$Maximize \qquad ( 10 )$$

$$HPL = \sqrt{{( {M}_{1} b )}^{2} + {( {M}_{2} b )}^{2}}$$

$$Subject to$$

$${b}^{T} Gb \leq λ$$

$${b}_{i , min} \leq {b}_{i} \leq {b}_{i , max} ( i = 1 , … , m )$$

Here, differential coefficients related to the positions that are differential coefficients included in the coefficient matrix H are expressed in an ENU coordinate system, which is a local horizontal coordinate system indicating three-dimensional positions, using the state quantities x₀ serving as a reference. When the coordinate transformation of the differential coefficients is required, the positioning calculation unit 11 or the protection level calculation unit 14 performs the coordinate transformation.

In the nonlinear programming problem shown in (10), M₁∈R^{1×(m+n)} is a row related to a position component in the east-west direction with respect to the reference three-dimensional position in a matrix M∈R^{n×(m+n)}. M₂∈R^{1×(m+n)} is a row related to a position component in the north-south direction with respect to the reference three-dimensional position in the matrix M∈R^{n×(m+n)}.

Here, the matrix M is expressed by equation (11) below.

$$Formula 8$$

$$M = {( [ \begin{matrix}{H}^{T} & I\end{matrix} ] [ \begin{matrix}{R}^{- 1} & O \\ O & {Q}^{- 1}\end{matrix} ] [ \begin{matrix}H \\ I\end{matrix} ] )}^{- 1} [ \begin{matrix}{H}^{T} & I\end{matrix} ] [ \begin{matrix}{R}^{- 1} & O \\ O & {Q}^{- 1}\end{matrix} ] \qquad ( 11 )$$

A matrix G∈R^{(m+n)} is expressed by equation (12) below.

$$Formula 9$$

$$G = [ \begin{matrix}\begin{matrix}{R}^{- 1} - {R}^{- 1} H ( {H}^{T} {R}^{- 1} H + \\ {{Q}^{- 1} )}^{- 1} {H}^{T} {R}^{- 1}\end{matrix} & - {R}^{- 1} {H ( {H}^{T} {R}^{- 1} H + {Q}^{- 1} )}^{- 1} {Q}^{- 1} \\ \begin{matrix}- {Q}^{- 1} ( {H}^{T} {R}^{- 1} H + \\ {{Q}^{- 1} )}^{- 1} {H}^{T} {R}^{- 1}\end{matrix} & {Q}^{- 1} - {{Q}^{- 1} ( {H}^{T} {R}^{- 1} H + {Q}^{- 1} )}^{- 1} {Q}^{- 1}\end{matrix} ] \qquad ( 12 )$$

As with the calculation of the horizontal protection level HPL, the protection level calculation unit 14 calculates the vertical protection level VPL, using the observation model, the weights in the positioning calculation, and the weights of the prior prediction values of the state quantities input from the positioning calculation unit 11, and the upper limit and the lower limit of the bias errors input from the bias error model unit 13. The vertical protection level VPL is obtained by solving a nonlinear programming problem shown in (13) below for a bias vector b∈R^{m+n}. The nonlinear programming problem shown in (13) can be solved by a general nonlinear programming solver.

$$Formula 10$$

$$Maximize \qquad ( 13 )$$

$$VPL = {M}_{3} b$$

$$Subject to$$

$${b}^{T} Gb \leq λ$$

$${b}_{i , min} \leq {b}_{i} \leq {b}_{i , max} ( i = 1 , … , m )$$

In the nonlinear programming problem shown in (13), M₃∈R^{1×(m+n)} is a row related to a position component in the up-and-down direction with respect to the reference three-dimensional position in the matrix M.

As described above, the positioning system 100 according to the first embodiment includes the protection level calculation system 1. The protection level calculation system 1 includes the protection level calculation device 3 that calculates the protection level used to determine the validity of the positioning solution. The protection level calculation device 3 calculates the protection level using the upper limit and the lower limit of a bias error assumed to be contained in each measurement. Therefore, if a measurement includes an anomalous value, when a bias error in this measurement is within the range between the upper limit and the lower limit, the protection level calculation system 1 can calculate the protection level effective for determining the validity of the positioning solution using this measurement.

Up to here, the description has been given of the case where both the positioning device 2 and the protection level calculation device 3 are incorporated in the positioning terminal 102, and the positioning terminal 102 calculates the positioning solution and the protection level. As described above, the positioning device 2 may be incorporated in the positioning terminal 102, and the protection level calculation device 3 may be incorporated in an external device such as the server 105. Alternatively, both the positioning device 2 and the protection level calculation device 3 may be incorporated in an external device such as the server 105.

For example, when both the positioning device 2 and the protection level calculation device 3 are incorporated in the positioning terminal 102, the positioning terminal 102 calculates the protection level using the upper limit and the lower limit of a bias error assumed to be contained in each measurement, and determines the validity of the positioning solution calculated using this measurement, using the protection level. A component for determining the validity of the positioning solution is not illustrated.

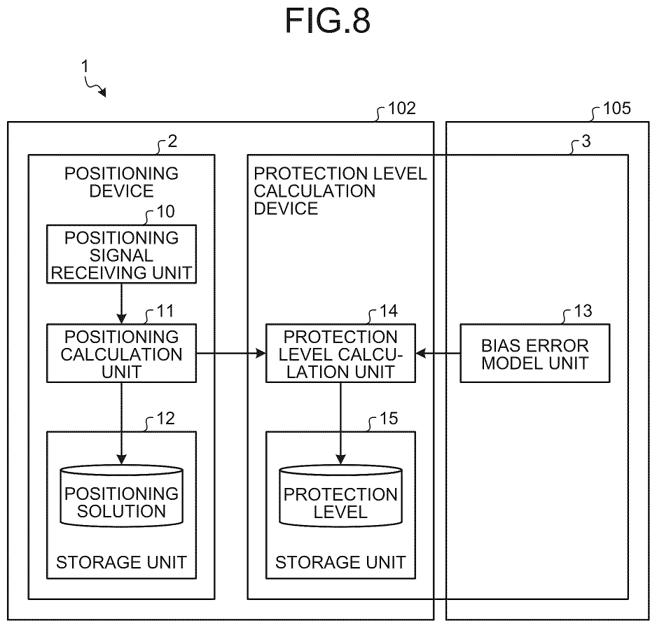

When the positioning terminal 102 calculates the protection level and determines the validity of the positioning solution, the positioning terminal 102 may store in advance the upper limit and the lower limit of a bias error assumed to be contained in each measurement in memory of the positioning terminal 102. Alternatively, as illustrated in FIG. 8 below, the positioning terminal 102 may receive the upper limit and the lower limit of a bias error from an external device such as the server 105 as integrity assistance data. Although the example in which the protection level calculation system 1 determines the validity of the measurement solution inside the positioning terminal 102 has been described, the present invention is not limited thereto. The protection level calculation system 1 may determine the validity of the measurement solution outside the positioning terminal 102. The validity of the measurement solution may be determined inside the protection level calculation device 3, or may be determined outside the protection level calculation device 3.

FIG. 8 is a diagram illustrating a first modification of the protection level calculation system 1 in the first embodiment. In the protection level calculation system 1 illustrated in FIG. 8, the positioning device 2, the protection level calculation unit 14, and the storage unit 15 are provided in the positioning terminal 102 that is a first device. The bias error model unit 13 is provided in the server 105 that is a second device that can communicate with the first device. The protection level calculation device 3 includes the protection level calculation unit 14 and the storage unit 15 of the positioning terminal 102, and the bias error model unit 13 of the server 105. In the configuration illustrated in FIG. 8, the positioning terminal 102 receives the upper limit and the lower limit of a bias error from the server 105 as integrity assistance data.

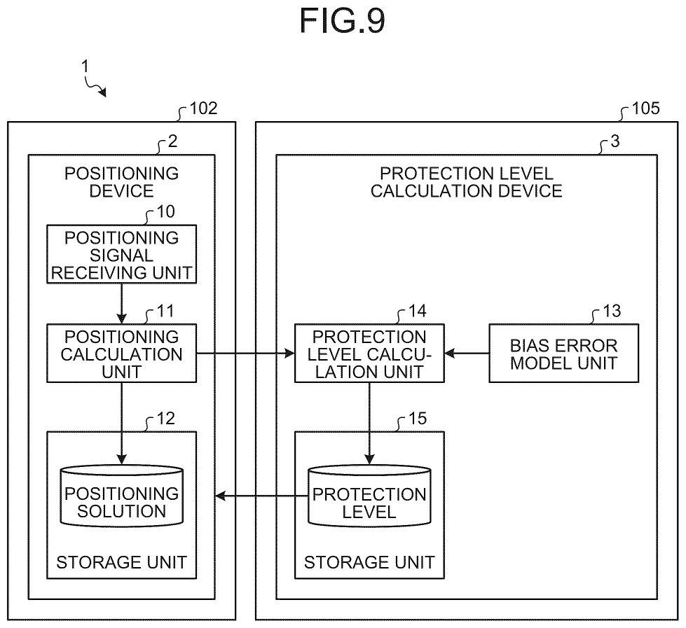

FIG. 9 is a diagram illustrating a second modification of the protection level calculation system 1 in the first embodiment. In the protection level calculation system 1 illustrated in FIG. 9, the positioning device 2 is incorporated in the positioning terminal 102, and the protection level calculation device 3 is incorporated in the server 105. That is, the positioning calculation unit 11 is incorporated in the positioning terminal 102 that is a first device, and the bias error model unit 13 and the protection level calculation unit 14 are incorporated in the server 105 that is a second device. The positioning device 2 transmits information on measurements to the server 105. The server 105 calculates the protection level using the upper limit and the lower limit of bias errors assumed to be contained in the received measurements at the protection level calculation unit 14. The server 105 transmits information on the calculated protection level to the positioning terminal 102. When receiving the information on the protection level, the positioning terminal 102 determines the validity of the positioning solution.

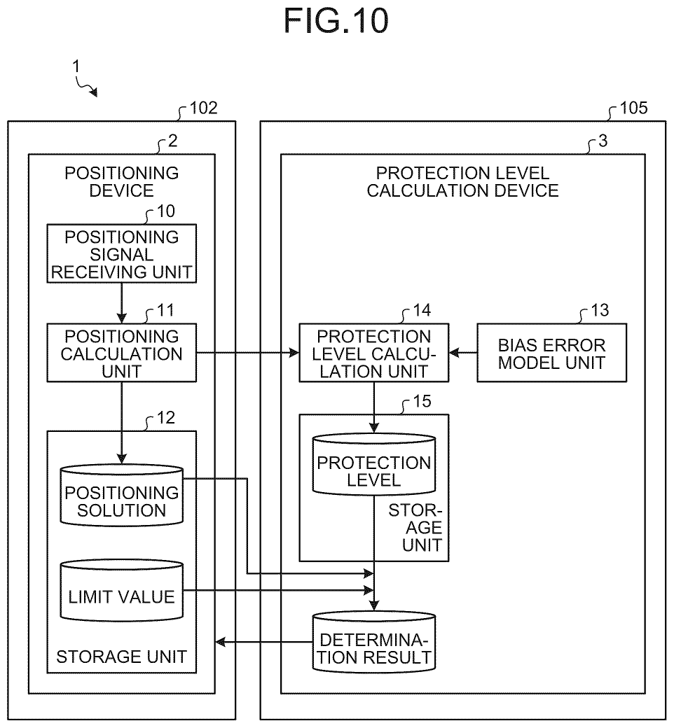

Instead of the positioning terminal 102 determining the validity of the positioning solution, an external device such as the server 105 may determine the validity of the positioning solution as illustrated in FIG. 10 below. FIG. 10 is a diagram illustrating a third modification of the protection level calculation system 1 in the first embodiment.

In the protection level calculation system 1 illustrated in FIG. 10, the positioning device 2 is incorporated in the positioning terminal 102, and the protection level calculation device 3 is incorporated in the server 105. That is, the positioning calculation unit 11 is incorporated in the positioning terminal 102 that is a first device, and the bias error model unit 13 and the protection level calculation unit 14 are incorporated in the server 105 that is a second device. The positioning terminal 102 transmits information on the positioning solution calculated by the positioning calculation unit 11 to the server 105. The server 105 determines the validity of the positioning solution using the protection level calculated in the protection level calculation unit 14. The server 105 transmits the validity determination result to the positioning terminal 102.

In the protection level calculation system 1 illustrated in FIG. 10, the positioning terminal 102 transmits the limit value determined by the application 101 to the server 105. Alternatively, the server 105 may acquire the limit value from a device other than the positioning terminal 102 via a communication network. Thus, by leaving processing to calculate the protection level or to determine the validity of the positioning solution to an external device, processing load on the positioning terminal 102 is reduced. Consequently, the protection level calculation system 1 allows the positioning terminal 102 to have a low-cost configuration.

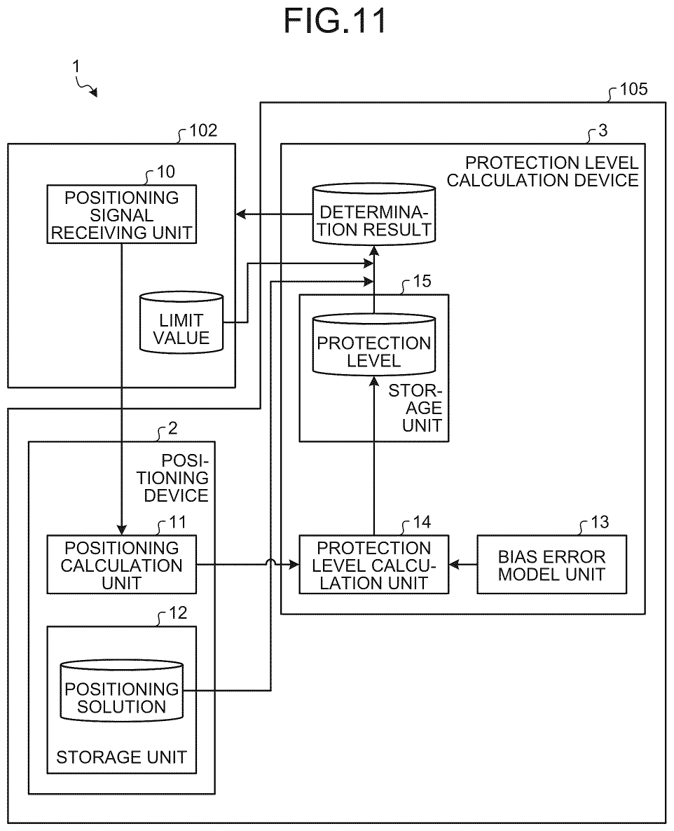

FIG. 11 is a diagram illustrating a fourth modification of the protection level calculation system 1 in the first embodiment. In the protection level calculation system 1 illustrated in FIG. 11, both the positioning device 2 and the protection level calculation device 3 are incorporated in the server 105. That is, the positioning calculation unit 11, the bias error model unit 13, and the protection level calculation unit 14 are incorporated in the server 105. The positioning signal receiving unit 10 is provided in the positioning terminal 102. When receiving the positioning signals, the positioning signal receiving unit 10 extracts measurements from the positioning signals. The positioning terminal 102 transmits the extracted measurements to the server 105.

When the server 105 receives the measurements, the positioning device 2 calculates the positioning solution. The protection level calculation device 3 calculates the protection level using the upper limit and the lower limit of bias errors assumed to be contained in the measurements. The server 105 compares the calculated protection level with the limit value determined by the application 101 to determine the validity of the positioning solution. The server 105 transmits the validity determination result to the positioning terminal 102.

In the protection level calculation system 1 illustrated in FIG. 11, the positioning terminal 102 transmits the limit value determined by the application 101 to the server 105. Alternatively, the server 105 may acquire the limit value from a device other than the positioning terminal 102 via a communication network. Thus, by leaving processing to calculate the protection level or to determine the validity of the positioning solution to an external device, processing load on the positioning terminal 102 is reduced. Consequently, the protection level calculation system 1 allows the positioning terminal 102 to have a low-cost configuration.

Even when both the positioning device 2 and the protection level calculation device 3 are incorporated in an external device such as the server 105, the positioning terminal 102 may calculate the positioning solution. In this case, the positioning terminal 102 that has calculated the positioning solution may receive information on the protection level from an external device such as the server 105 and determine the validity of the positioning solution.

Each of the protection level calculation systems 1 illustrated in FIGS. 10 and 11 determines the validity of the measurement solution inside the protection level calculation device 3 in the server 105, and outputs the determination result from the protection level calculation device 3, but the present invention is not limited thereto. The protection level calculation system 1 may determine the validity of the measurement solution outside the protection level calculation device 3 in the server 105, and output the determination result from outside the protection level calculation device 3 in the server 105.

Regardless of whether each of the positioning device 2 and the protection level calculation device 3 is incorporated in the positioning terminal 102 or an external device such as the server 105, the positioning calculation unit 11, the bias error model unit 13, and the protection level calculation unit 14 are implemented by the control circuit 50 illustrated in FIG. 3 or the hardware circuit 55 illustrated in FIG. 4.

As described above, regardless of whether each of the positioning device 2 and the protection level calculation device 3 is incorporated in the positioning terminal 102 or an external device such as the server 105, the protection level calculation system 1 calculates the protection level using the upper limit and the lower limit of a bias error assumed to be contained in each measurement. Consequently, when a bias error in each measurement used in the calculation of the positioning solution is included in the range between the upper limit and the lower limit of this bias error, if a measurement includes an anomalous value, the protection level calculation system 1 can calculate the protection level effective for determining the validity of the positioning solution using this measurement. Thus, in a situation where measurements may include an anomalous value, the protection level calculation system 1 can calculate the protection level effective for determining the validity of the positioning solution calculated from the measurements.

### Second Embodiment

Errors due to positioning satellites or errors due to the atmosphere, which are errors contained in measurements, are usually corrected and then used in positioning calculation. A second embodiment describes a case in which measurements are corrected using correction information uniformly distributed from a quasi-zenith satellite or correction information provided from a reference station 202 described below via a communication network, and a protection level is calculated for the corrected measurements. In the second embodiment, the same reference numerals are assigned to the same components as those in the first embodiment, and a configuration different from that of the first embodiment will be mainly described.

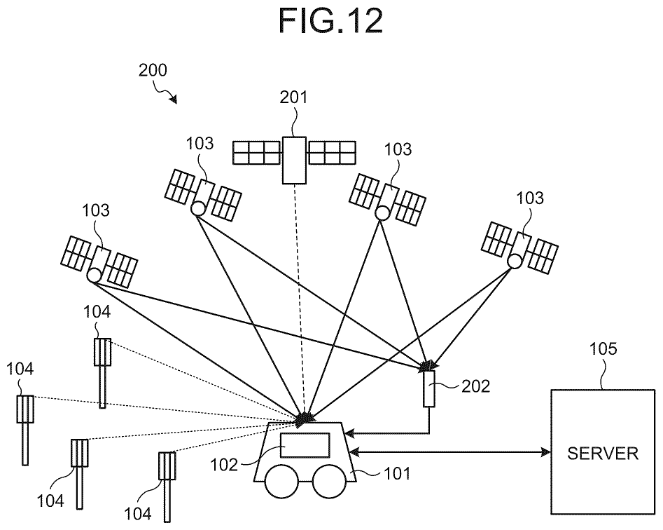

FIG. 12 is a diagram illustrating a configuration example of a positioning system 200 according to the second embodiment. The positioning system 200 includes a positioning augmentation satellite 201 and a reference station (a continuously operating reference station: CORS) 202, in addition to the same configuration as that of the positioning system 100 according to the first embodiment. The reference station 202 is a station equipped with a positioning terminal whose accurate position is known.

The positioning augmentation satellite 201 and the reference station 202 buffer correction information and transmit the correction information to the positioning terminal 102 at a preset timing. Here, the correction information is information to correct errors contained in measurements. The correction information is uniformly distributed from a quasi-zenith satellite that is an example of the positioning augmentation satellite 201, or provided from the reference station 202 via the communication network. The correction information provided by the reference station 202 is different from the correction information uniformly distributed by the positioning augmentation satellite 201 and repeatedly transmitted by the base station 104.

The satellites 103 transmit positioning signals. The positioning terminal 102 receives the positioning signals and determines the position of the application 101. The positioning augmentation satellite 201 transmits a correction information signal. The positioning terminal 102 receives the correction information signal and corrects measurements. Note that the base stations 104 or the server 105 may repeatedly transmit the correction information transmitted by the positioning augmentation satellite 201 to the positioning terminal 102 via a communication network, in preparation for a case where the positioning terminal 102 fails to receive the correction information signal from the positioning augmentation satellite 201 due to its entry into the shadow of a building or the like.

When receiving the positioning signals from the signal sources, the positioning terminal 102 extracts information on the positions of the signal sources and information on the distances between the application 101 and the signal sources as measurements. Since the measurements include errors, the positioning terminal 102 corrects the extracted measurements, using the correction information received from the positioning augmentation satellite 201 or the reference station 202. Then, the positioning terminal 102 calculates the positioning solution of the application 101 using the corrected measurements. The errors corrected using the correction information are at least either errors due to the positioning satellites or errors due to the atmosphere.

The measurements also include errors due to the reception environment or the receiver. Therefore, the positioning terminal 102 uses the protection level to determine the validity of the calculated positioning solution. The positioning terminal 102 calculates the protection level, using an observation model corresponding to the measurements used in the positioning calculation and weights in the positioning calculation. That is, the positioning terminal 102 calculates the protection level. Then, the positioning terminal 102 compares the calculated protection level with a limit value of the application 101, and determines whether or not the calculated positioning solution can be used. A specific method of calculating the protection level will be described later.

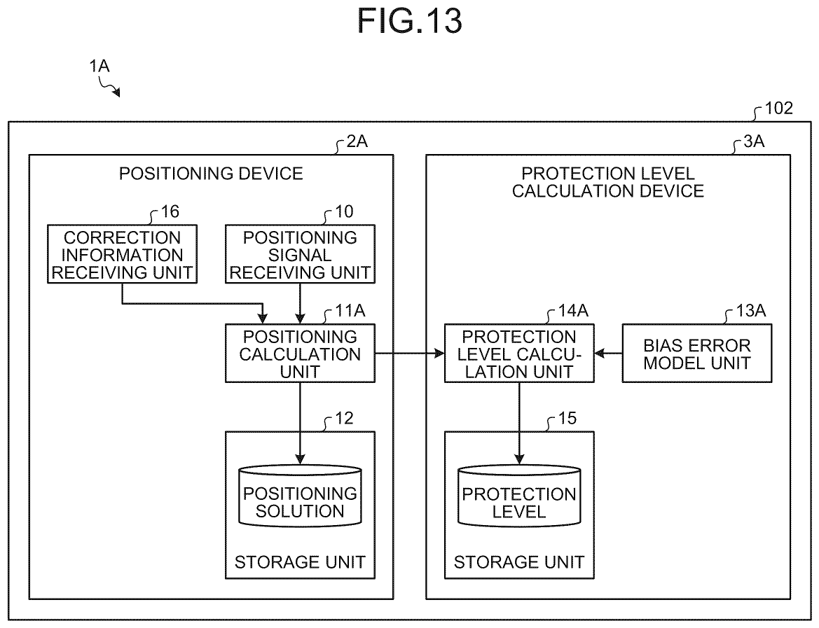

The positioning system 200 includes a protection level calculation system that calculates the protection level. Here, a configuration of the protection level calculation system will be described. FIG. 13 is a diagram illustrating a configuration example of a protection level calculation system 1A included in the positioning system 200 according to the second embodiment. The protection level calculation system 1A illustrated in FIG. 2 includes a positioning device 2A that performs positioning and a protection level calculation device 3A that calculates the protection level.

Here, a description is given of a case where both the positioning device 2A and the protection level calculation device 3A are incorporated in the positioning terminal 102 illustrated in FIG. 12. Note that the positioning device 2A may be incorporated in the positioning terminal 102, and the protection level calculation device 3A may be incorporated in the server 105 or the like that is a device outside the positioning terminal 102. Alternatively, both the positioning device 2A and the protection level calculation device 3A may be incorporated in an external device such as the server 105. When the positioning device 2A is incorporated in a device other than the positioning terminal 102, the positioning signal receiving unit 10 described below is included in the positioning device 2A.

The positioning device 2A includes the positioning signal receiving unit 10 that receives positioning signals transmitted by the signal sources, a positioning calculation unit 11A that performs positioning calculation, and the storage unit 12 that stores information. The positioning signal receiving unit 10 includes an antenna and a receiver. Here, a correction information receiving unit 16 may share at least one of the antenna and the receiver with the positioning signal receiving unit 10. Alternatively, the correction information receiving unit 16 may include an antenna and a receiver different from those of the positioning signal receiving unit 10. The antenna and the receiver are not illustrated. The storage unit 12 stores the positioning solution calculated by the positioning calculation unit 11A.

The positioning device 2A includes the correction information receiving unit 16 in addition to the same configuration as that of the positioning device 2 illustrated in FIG. 2. The correction information receiving unit 16 includes the antenna and the receiver. The antenna and the receiver are not illustrated. The correction information receiving unit 16 receives the correction information transmitted by each of the positioning augmentation satellite 201 and the reference station 202. Each of the positioning augmentation satellite 201 and the reference station 202 is a signal source of a correction information signal.

The protection level calculation device 3A includes a bias error model unit 13A that outputs the upper limit and the lower limit of a bias error, a protection level calculation unit 14A that calculates the protection level of the positioning solution, and the storage unit 15 that stores information. The protection level calculation device 3A has the same configuration as the protection level calculation device 3 illustrated in FIG. 2. This bias error is a bias error that remains even when correction based on the correction information is performed, of bias errors assumed to be contained in measurements obtained from the positioning signals.

The positioning calculation unit 11A, the bias error model unit 13A, and the protection level calculation unit 14A of the protection level calculation system 1A are implemented by the control circuit 50 illustrated in FIG. 3 or the hardware circuit 55 illustrated in FIG. 4. Part of the positioning signal receiving unit 10 and part of the correction information receiving unit 16 may be a processing circuit.

The following describes a case where the signal sources of the positioning signals are the satellites 103. When receiving the positioning signals from the satellites 103, the positioning signal receiving unit 10 extracts information on the positions of the satellites 103 and information on the distances between the application 101 and the satellites 103 as measurements. The positioning signal receiving unit 10 outputs the extracted measurements to the positioning calculation unit 11A. Each measurement output by the positioning signal receiving unit 10 includes at least one of a bias error due to the satellite 103 such as a satellite clock error, an orbit error, or a satellite inter-signal bias, a bias error due to the atmosphere such as an ionospheric delay or a tropospheric delay, or a bias error due to the receiver such as a receiver clock error or a receiver inter-signal bias.

The correction information receiving unit 16 receives the correction information signal transmitted by the positioning augmentation satellite 201 or the reference station 202, and outputs the correction information to the positioning calculation unit 11A. Here, the correction information received by the correction information receiving unit 16 is, for example, information broadcast by the Centimeter Level Augmentation Service provided by the Quasi-Zenith Satellite System. Using the correction information, the positioning calculation unit 11A corrects the bias errors due to the satellites 103 and the bias errors due to the atmosphere, of the bias errors contained in the measurements.

The positioning calculation unit 11A calculates the positioning solution using the corrected measurements. In addition to the positioning solution, the positioning calculation unit 11A outputs pieces of information on the observation model corresponding to the measurements from the signal sources used in the positioning calculation and the weights in the positioning calculation. The positioning solution calculated by the positioning calculation unit 11A may include information on speed, acceleration, or the like.

When the reference station 202 is disposed near the positioning terminal 102, the positioning calculation unit 11A may correct the measurements input from the positioning signal receiving unit 10, using measurements of the reference station 202 instead of the correction information received from the positioning augmentation satellite 201, the base stations 104, or the server 105. Specifically, the correction information receiving unit 16 receives measurements from the reference station 202, and outputs the received measurements directly to the positioning calculation unit 11A. Communication between the reference station 202 and the positioning device 2A is performed, for example, by wireless communication via a mobile phone network or the like.

The positioning calculation unit 11A uses the measurements at the reference station 202 input from the correction information receiving unit 16 as correction values, and subtracts the correction values from the measurements input from the positioning signal receiving unit 10. In this manner, the positioning calculation unit 11A obtains the measurements corrected for the bias errors due to the satellites 103 and the bias errors due to the atmosphere. The positioning calculation unit 11A performs positioning calculation using the corrected measurements to calculate the positioning solution.

When measurements at the reference station 202 are used as correction information, the corrected measurements include bias errors due to the surrounding environment of the reference station 202. Therefore, the reference station 202 is usually installed in an open sky environment to be able to ignore bias errors due to the surrounding environment.

The positioning device 2A sends the positioning solution, the observation model, and the weights in the positioning calculation output from the positioning calculation unit 11A to the protection level calculation device 3A. The pieces of information on the positioning solution, the observation model, and the weights in the positioning calculation are input to the protection level calculation unit 14A. The upper limit and the lower limit of the bias error output from the bias error model unit 13A are input to the protection level calculation unit 14A. The protection level calculation unit 14A calculates the protection level of the positioning solution, using the observation model and the weights in the positioning calculation, and the upper limit and the lower limit of the bias error. The protection level calculated by the protection level calculation unit 14A is stored in the storage unit 15.

Next, a method of calculating the protection level in the second embodiment will be described. The positioning calculation unit 11A outputs a coefficient matrix H∈R^{m×n} as an observation model corresponding to corrected measurements y_{c}∈R^{m} used in the positioning calculation. The coefficient matrix H∈R^{m×n} is obtained by linearizing a nonlinear observation model h(x)∈R^{m} for the measurements based on state quantities x∈Rⁿ around state quantities x₀∈Rⁿ serving as a reference. Note that the state quantities x∈R^{m} include three-dimensional position information on the positioning terminal 102. Here, m represents the number of dimensions of the measurements used in the positioning calculation. n represents the number of dimensions of the state quantities estimated by the positioning calculation.

For example, each diagonal element of the error covariance matrix is σ_{yi}²+σₒᵢ² that is the sum of the error variance σ_{yi}² of each measurement yᵢ∈y and the error variance σ_{ci}² of a correction value c, corrected for the bias error due to the satellite 103 and the bias error due to the atmosphere. Here, the correction value cᵢ is a value obtained by correcting the measurement yᵢ received by the positioning signal receiving unit 10, using the correction information received by the correction information receiving unit 16.

When the positioning calculation unit 11A calculates the positioning solution using measurements yr at the reference station 202 instead of the correction information received from the positioning augmentation satellite 201 or the reference station 202, each diagonal element of the error covariance matrix is σ_{yi}²+σ_{yri}² that is the sum of the error variance ay of a measurement at the positioning terminal 102 and the error variance σ_{yri}² of a measurement at the reference station 202 that is a measurement from the same signal source as that of the measurement at the positioning terminal 102.

The error variance σ_{yi}² of a measurement at the positioning terminal 102 can be determined using, for example, a model generated in advance as a function of the signal type or the signal elevation angle. The error variance σ_{ci}² of a correction value corrected for the bias error due to the satellite 103 and the bias error due to the atmosphere, and the error variance σ_{yri}² of a measurement at the reference station 202 that is a measurement from the same signal source as that of a measurement at the positioning terminal 102, can be determined using a model generated in advance as a function of the signal type or the signal elevation angle. When the values of these error variances are included in the correction information, the values included in the correction information may be used.

The bias error model unit 13A outputs the upper limit b_{env_max}∈R^{m} of a bias error and the lower limit b_{env_min}∈R^{m} of the bias error. This bias error is a bias error due to the surrounding environment, assumed to be contained in each measurement used in the positioning calculation, and varies from measurement to measurement. That is, here, it is assumed that, of the bias errors contained in the measurements, the bias errors due to the satellites 103 and the bias errors due to the atmosphere are removed by the correction, and only the bias errors due to the surrounding environment remain.

The protection level calculation unit 14A calculates the horizontal protection level HPL, using the observation model and the weights in the positioning calculation input from the positioning calculation unit 11A, and the upper limit and the lower limit of the bias error input from the bias error model unit 13A. The horizontal protection level HPL is obtained by solving a nonlinear programming problem shown in (14) below for a bias vector bₑₙᵥ∈R^{m}. The nonlinear programming problem shown in (14) can be solved by a general nonlinear programming solver.

$$Formula 11$$

$$Maximize \qquad ( 14 )$$

$$HPL = \sqrt{{( {M}_{1} {b}_{env} )}^{2} + {( {M}_{2} {b}_{env} )}^{2}}$$

$$Subject to$$

$${b}_{env}^{T} {Gb}_{env} \leq λ$$

$${b}_{i , env \_ min} \leq {b}_{i , env} \leq {b}_{i , env \_ max} ( i = 1 , … , m )$$

Here, differential coefficients related to the positions that are differential coefficients included in the coefficient matrix H are expressed in an ENU coordinate system that is a local horizontal coordinate system based on a three-dimensional position given by state quantities x₀ serving as a reference.

In the nonlinear programming problem shown in (14), M₁∈R^{1×m} is a row related to a position component in the east-west direction with respect to the reference three-dimensional position in a matrix M=(H^{T}R⁻¹H)⁻¹H^{T}R⁻¹∈R^{n×m}. M∈R^{1×m} is a row related to a position component in the north-south direction with respect to the reference three-dimensional position in the matrix M=(H^{T}R⁻¹H)⁻¹H^{T}R⁻¹∈R^{n×m}. A matrix G∈R^{m×m} is expressed as G=(R⁻¹−R⁻¹H(H^{T}R⁻¹H)⁻¹H^{T}R⁻¹). b_{i,env_min} is an element of b_{env_min}. b_{i,env_max} is an element of b_{env_max}. i is a measurement index.

As with the calculation of the horizontal protection level HPL, the protection level calculation unit 14A calculates the vertical protection level VPL, using the observation model and the weights in the positioning calculation input from the positioning calculation unit 11A, and the upper limit and the lower limit of the bias error input from the bias error model unit 13A. The vertical protection level VPL is obtained by solving a nonlinear programming problem shown in (15) below for a bias vector bₑₙᵥ∈R^{m}. The nonlinear programming problem shown in (15) can be solved by a general nonlinear programming solver.

$$Formula 12$$

$$Maximize \qquad ( 15 )$$

$$VPL = {M}_{3} b$$

$$Subject to$$

$${b}^{T} Gb \leq λ$$

$${b}_{i , min} \leq {b}_{i} \leq {b}_{i , max} ( i = 1 , … , m )$$

In the nonlinear programming problem shown in (15), M₃∈R^{1×m} is a row related to a position component in the up-and-down direction with respect to the reference three-dimensional position in the matrix M.

The protection level calculation unit 14A may calculate the protection level, further using the standard bias errors in the correction values for correcting the measurements. For example, constraints of the nonlinear programming problem may be changed as shown in (16) below, using the standard bias error μ_{ci}>0 in each correction value.

$$Formula 13$$

$$Subject to \qquad ( 16 )$$

$${b}_{env}^{T} {Gb}_{env} \leq λ$$

$${b}_{i , env \_ min} - {μ}_{{c}_{i}} \leq {b}_{i , env} \leq {b}_{i , env \_ max} + {μ}_{{c}_{i}} ( i = 1 , … , m )$$

The standard bias error μ_{ci} in each correction value can be determined using a model generated in advance as a function of the signal type or the signal elevation angle. When the value of the standard bias error μ_{ci} in each correction value is included in the correction information, the value included in the correction information may be used. For example, the literature “J. Rife, et. al, ‘Paired Overbounding and Application to GPS Augmentation’, PLANS 2004. Position Location and Navigation Symposium” discloses a method in which an error in a correction value derived from correction information is expressed by a paired Gaussian distribution, and the error variance σ_{ci}² of a correction value, that is, a correction value corrected for a bias error due to a satellite and a bias error due to the atmosphere, and a parameter corresponding to the standard bias error μ_{ci} in each correction value are provided as part of correction information.

As described above, by adding the standard bias errors in the correction values in the calculation of the protection level, the protection level calculation system 1A calculates the protection level assuming the bias errors due to the satellites 103 and the bias errors due to the atmosphere, which may remain even when correction based on the correction information is performed, in addition to the bias errors due to the surrounding environment. Therefore, the protection level calculation system 1A can calculate the protection level effective for determining the validity of the positioning solution.

The positioning calculation unit 11A may calculate the positioning solution by observation update with the Kalman filter or the like using prior prediction values of the state quantities. In this case, each of the positioning calculation unit 11A, the bias error model unit 13A, and the protection level calculation unit 14A is extended as in the first embodiment.

As described above, the positioning system 200 according to the second embodiment includes the positioning augmentation satellite 201 and the reference station 202 in addition to the same configuration as that of the positioning system 100. The protection level calculation system 1A including the protection level calculation device 3A corrects measurements at the positioning device 2A, using correction information to correct bias errors due to the satellites 103 and bias errors due to the atmosphere, or measurements at the reference station 202.

In the conventional protection level calculation device using the multivariate probability distribution model, although the types and reliability of indicators of measurement quality recorded by the receiver are values unique to the receiver, some indicators are not externally output, and the available range is limited. By contrast, the protection level calculation device 3A of the second embodiment focuses, for example, on bias errors due to the environment around the positioning terminal 102, and calculates the protection level using the upper limit and the lower limit of a bias error assumed to be contained in each corrected measurement. The surrounding environment is, for example, blocking of the direct wave of a signal by a building or multipath.

The upper limit and the lower limit of a bias error in each measurement are obtained from a geometric environment model that is a model of the surrounding environment. The bias error model unit 13A determines each of the upper limit and the lower limit of a bias error based on an environment model that is a model of the environment around the application 101 that is an object of positioning. Consequently, by using the protection level calculation device 3A, the protection level calculation system 1A can calculate the protection level effective for determining the validity of the positioning solution without depending on the type or performance of the receiver, in addition to the effects described in the first embodiment. The protection level calculation system 1A can calculate the protection level reflecting the individual surrounding environment by using the geometric environment model that is a model of the surrounding environment.

Up to here, the description has been given of the case where the signal sources of the positioning signals are the satellites 103. When the signal sources are the base stations 104, measurements do not include errors due to the satellites and errors due to the atmosphere, and thus the protection level calculation system 1A does not perform correction using correction information. On the other hand, even when the signal sources are the base stations 104, bias errors due to the surrounding environment are contained in measurements. Therefore, the protection level calculation system 1A calculates the protection level using the upper limit and the lower limit of a bias error assumed to be contained in each measurement, as in the case where the signal sources of the positioning signals are the satellites 103.

### Third Embodiment

A third embodiment describes a case in which from a roadside unit installed beside a road, time information indicating the time at which the application 101 has passed, and position information on the roadside unit or the application 101 are received, and a protection level is calculated using these pieces of information and map information. In the third embodiment, the same reference numerals are assigned to the same components as those in the first or second embodiment, and a configuration different from that of the first or second embodiment will be mainly described.

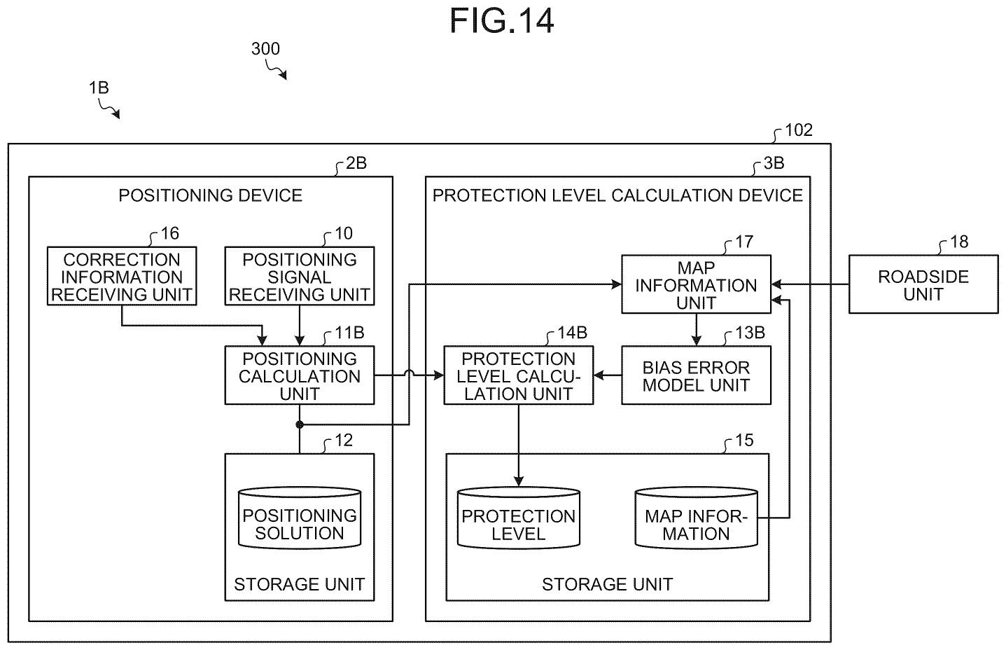

FIG. 14 is a diagram illustrating a configuration example of a protection level calculation system 1B included in a positioning system 300 according to the third embodiment. The positioning system 300 according to the third embodiment includes a protection level calculation system 1B different from the protection level calculation system 1A illustrated in FIG. 13. The protection level calculation system 1B includes a positioning device 2B that performs positioning, a protection level calculation device 3B that calculates a protection level, and a roadside unit 18.

Here, a description is given of a case where both the positioning device 2B and the protection level calculation device 3B are incorporated in the positioning terminal 102. Note that the positioning device 2B may be incorporated in the positioning terminal 102, and the protection level calculation device 3B may be incorporated in the server 105 or the like that is a device outside the positioning terminal 102. Alternatively, both the positioning device 2B and the protection level calculation device 3B may be incorporated in an external device such as the server 105. When the positioning device 2B is incorporated in a device other than the positioning terminal 102, the positioning signal receiving unit 10 is included in the positioning device 2B.

The roadside unit 18 is a device equipped with a sensor such as a camera and a clock, installed beside a road. The roadside unit 18 detects the application 101 with the sensor such as the camera. When detecting the passage of the application 101 in front of the roadside unit 18, the roadside unit 18 outputs position information on the roadside unit 18 as position information on the application 101 at the time when the application 101 has passed. Note that the roadside unit 18 may measure the relative position between the roadside unit 18 and the application 101 to determine the absolute position of the application 101, and output information on the determined position as position information on the application 101.

The positioning device 2B includes the positioning signal receiving unit 10 that receives positioning signals transmitted by signal sources that are the satellites 103 or the base stations 104, a positioning calculation unit 11B that performs positioning calculation, the storage unit 12 that stores information, and the correction information receiving unit 16. The positioning device 2B has the same configuration as the positioning device 2A of the protection level calculation system 1A. Note that the positioning device 2B may have the same configuration as the positioning device 2 of the protection level calculation system 1 illustrated in FIG. 2.

The protection level calculation device 3B includes a bias error model unit 13B that outputs the upper limit and the lower limit of a bias error, a protection level calculation unit 14B that calculates the protection level of a positioning solution, the storage unit 15 that stores information, and a map information unit 17. The storage unit 15 stores the protection level and map information.

The positioning terminal 102 receives position information transmitted from the roadside unit 18. The received position information is input to the map information unit 17. Further, the positioning solution output from the positioning calculation unit 11B of the positioning device 2B is input to the map information unit 17. The map information unit 17 reads the map information stored in the storage unit 15. The map information unit 17 refers to the map information, using the input positioning solution or position information on the application 101, and determines the class of the environment around the application 101. Here, surrounding environments are classified into a plurality of classes such as suburbs, semi-urban areas, and urban areas, according to differences in the magnitude and occurrence frequency of a bias error due to the surrounding environment such as a multipath error. The bias error due to the surrounding environment is the smallest in the suburb and the largest in the urban area. That is, the class of the surrounding environment represents the magnitude or occurrence frequency of the bias error due to the surrounding environment.

The map information unit 17 determines which class the environment around the application 101 corresponds to, and outputs the determined result to the bias error model unit 13B. Thus, the map information unit 17 refers to the map information using the positioning solution or the position information on the application 101, thereby determining the class representing the magnitude or occurrence frequency of the bias error due to the environment for the environment around the application 101.

The bias error model unit 13B holds models of the upper limit and the lower limit of the bias error for the respective surrounding environment classes. According to the class determined by the map information unit 17, the bias error model unit 13B selects the corresponding model of the upper limit and the lower limit of the bias error. The bias error model unit 13B calculates the upper limit and the lower limit of the bias error, using an environment model that is the selected model. That is, the bias error model unit 13B determines the upper limit and the lower limit of the bias error, using an environment model corresponding to the class determined by the map information unit 17.

In this manner, the bias error model unit 13B calculates the upper limit and the lower limit of the bias error due to the environment around the application 101, of the bias errors assumed to be contained in the measurements. The bias error model unit 13B outputs the results of the calculation of the upper limit and the lower limit of the bias error to the protection level calculation unit 14B.

The positioning calculation unit 11B, the bias error model unit 13B, the protection level calculation unit 14B, and the map information unit 17 of the protection level calculation system 1B are implemented by the control circuit 50 illustrated in FIG. 3 or the hardware circuit 55 illustrated in FIG. 4.

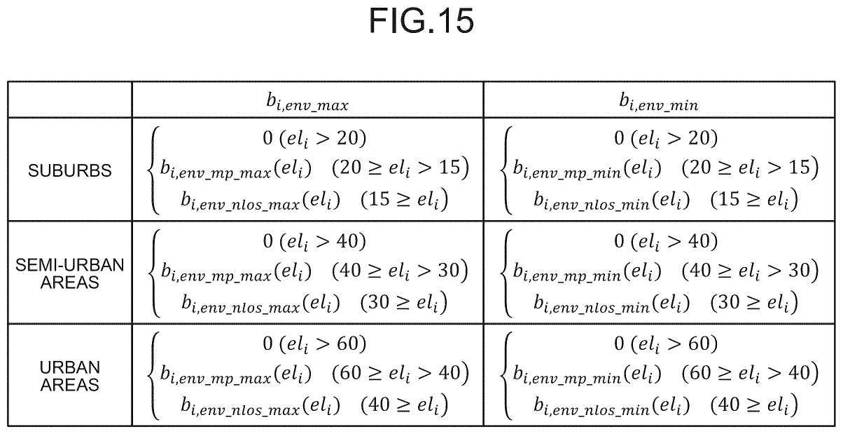

Here, an example of the models of the upper limit and the lower limit of the bias error that are different for each surrounding environment class will be described. FIG. 15 is a diagram illustrating an example of the models of the upper limit and the lower limit of the bias error used by the protection level calculation system 1B of the third embodiment. FIG. 15 illustrates an example of the model of each class for each of the upper limit b_{i,env_max} and the lower limit b_{i,env_min}, with the environment classified into suburbs, semi-urban areas, and urban areas.

For example, in the literature “GSG-5/6 Series GNSS Simulator User Manual with SCPI Guide”, in order to model bias errors due to the surrounding environment, the elevation angle is classified into the Open Sky Zone, the Multipath Zone, and the Obstruction Zone. In the Open Sky Zone, there are no multipath errors, and there are no bias errors due to the surrounding environment. In the Multipath Zone, direct waves from the positioning satellites are not blocked, but multipath errors occur. In the Obstruction Zone, direct waves from the positioning satellites are blocked, and only indirect waves are received, causing non-line-of-sight (NLOS) errors.

The surrounding environment classes are distinguished by elevation angles at which the three zones are changed. Therefore, for example, when the upper limit b_{i,env_max} and the lower limit b_{i,env_min} of the bias error due to a multipath error are expressed as functions b_{i,env_mp_max}(elᵢ) and b_{i,env_mp_min}(elᵢ) of the elevation angle elᵢ of the satellite 103, respectively, and the upper limit and the lower limit of the bias error due to an NLOS error is expressed as functions b_{i,env_max}(elᵢ) and b_{i,env_nlos_min}(elᵢ) of the elevation angle elᵢ of the satellite 103, respectively, the upper limit b_{i,env_max} and the lower limit b of the bias error that are different for each surrounding environment class are expressed as illustrated in FIG. 15.

As described above, the positioning system 300 according to the third embodiment includes the roadside unit 18 in addition to the same configuration as that of the positioning system 100 or the positioning system 200. The protection level calculation device 3B included in the protection level calculation system 1B is a device that calculates the protection level to be used to determine the validity of the positioning solution, and includes the bias error model unit 13B and the map information unit 17. The map information unit 17 refers to the map information, using the positioning solution output by the positioning calculation unit 11B or the position information on the application 101 output by the roadside unit 18, and determines the class of the surrounding environment. The bias error model unit 13B selects the model of the upper limit of the bias error and the model of the lower limit of the bias error according to the class determined by the map information unit 17. The bias error model unit 13B calculates the upper limit and the lower limit of the bias error due to the surrounding environment, using the selected model. The protection level calculation unit 14B calculates the protection level using the upper limit and the lower limit of the bias error calculated by the bias error model unit 13B. Therefore, even when a measurement includes an anomalous value, the protection level calculation system 1B can not only determine the validity of the positioning solution using this measurement but also calculate the protection level reflecting the magnitude or occurrence frequency of the multipath error or the NLOS error. By using the protection level calculation device 3B, the protection level calculation system 1B can calculate the more accurate protection level, in addition to the effects described in the first or second embodiment.

The map information unit 17 may refer to the map information stored in the storage unit 15, and output a three-dimensional model of the surrounding environment from the positioning solution output by the positioning calculation unit 11B or the position information on the application 101 output by the roadside unit 18. The map information is three-dimensional map information such as a dynamic map. In this case, the bias error model unit 13B determines the upper limit and the lower limit of an error in each measurement, using an environment model that is the three-dimensional model output by the map information unit 17. The environment model is a geometric model obtained from the three-dimensional map information.

By using the geometric model obtained from the three-dimensional map information as the environment model, the protection level calculation system 1B can calculate the more accurate protection level reflecting the individual surrounding environment as compared with the case of using a stepwise rough model. By using the protection level calculation device 3B, the protection level calculation system 1B can calculate the more accurate protection level, in addition to the effects described in the first or second embodiment.

In general, in the calculation of the upper limit and the lower limit of a bias error using a three-dimensional map, or the like, it is expensive to hold the latest map and to calculate the upper limit and the lower limit of the bias error from the height of a building and the distance from the application 101 to the building. For example, when the protection level calculation device 3B is disposed in the server 105, the application 101 can reduce the cost, in addition to the above-described effects.

Up to here, the description has been given of the case where both the positioning device 2B and the protection level calculation device 3B are incorporated in the positioning terminal 102. As in the first embodiment, the positioning device 2B may be incorporated in the positioning terminal 102, and the protection level calculation device 3B may be incorporated in an external device such as the server 105. Alternatively, both the positioning device 2B and the protection level calculation device 3B may be incorporated in an external device such as the server 105.

In the protection level calculation system 1B, the application 101 equipped with the positioning terminal 102 may receive the upper limit and the lower limit of a bias error in each measurement calculated by the server 105 as integrity assistance data to calculate the protection level. Alternatively, the application 101 equipped with the positioning terminal 102 may receive the result of calculation of the protection level from the server 105 or the like, or may receive the result of determination of whether or not the positioning solution can be used based on a comparison between a limit value determined by the application 101 and the protection level.

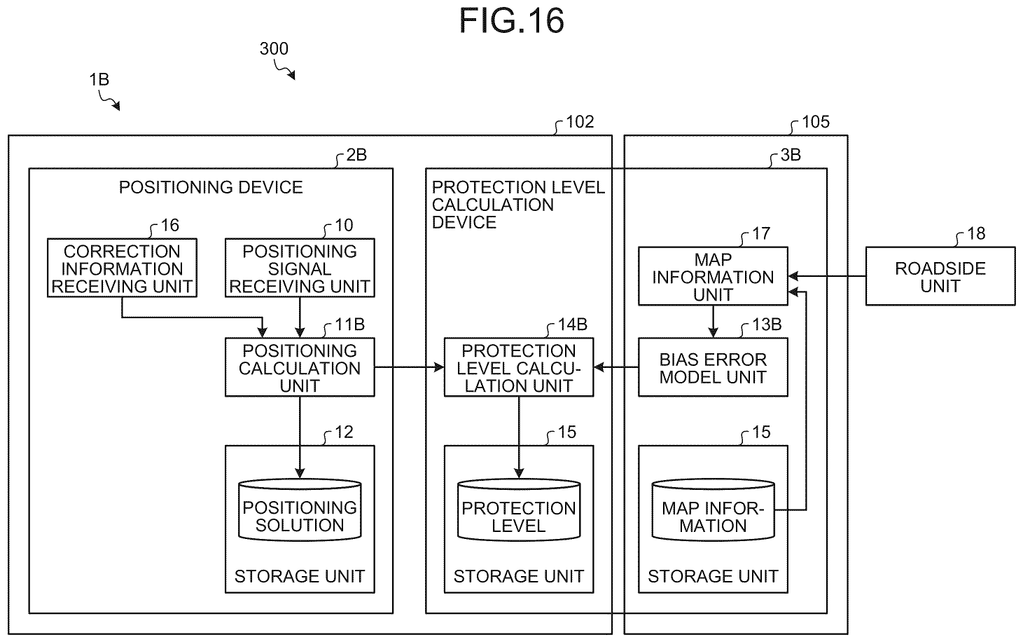

FIG. 16 is a diagram illustrating a modification of the protection level calculation system 1B included in the positioning system 300 according to the third embodiment. In the protection level calculation system 1B illustrated in FIG. 16, the positioning device 2B, the protection level calculation unit 14B, and the storage unit 15 that stores the protection level are provided in the positioning terminal 102 that is a first device. The bias error model unit 13B, the map information unit 17, and the storage unit 15 that stores the map information are provided in the server 105 that is a second device. The protection level calculation device 3B includes the protection level calculation unit 14B and the storage unit 15 of the positioning terminal 102, and the bias error model unit 13B, the map information unit 17, and the storage unit 15 of the server 105. In the configuration illustrated in FIG. 16, the positioning terminal 102 receives the upper limit and the lower limit of a bias error from the server 105 as integrity assistance data.

In the configuration illustrated in FIG. 16, the server 105 can acquire the position information on the application 101 from the roadside unit 18 via a communication network such as a mobile phone network without involving the application 101. Consequently, when the server 105 has orbit information on the satellites 103, the positioning system 300 can calculate the upper limit and the lower limit of bias errors in measurements corresponding to all the satellites 103 that can be measured by the application 101. Note that the application 101 can receive the upper limit and the lower limit of a bias error in each measurement as integrity assistance data without transmitting measurement information and the positioning solution to the server 105.

### Fourth Embodiment

The first to third embodiments have described the case where the protection level of the positioning solution calculated from pseudo-range measurements is calculated. In a fourth embodiment, a protection level is calculated by taking into account errors in integer ambiguities solved by positioning calculation using carrier-phase measurements in addition to pseudo-range measurements. Carrier-phase measurements are suitable for precise distance measurement. However, if there is an error in an integer solved, that becomes a bias error. In the fourth embodiment, the same reference numerals are assigned to the same components as those in the first to third embodiments, and a configuration different from those of the first to third embodiments will be mainly described.

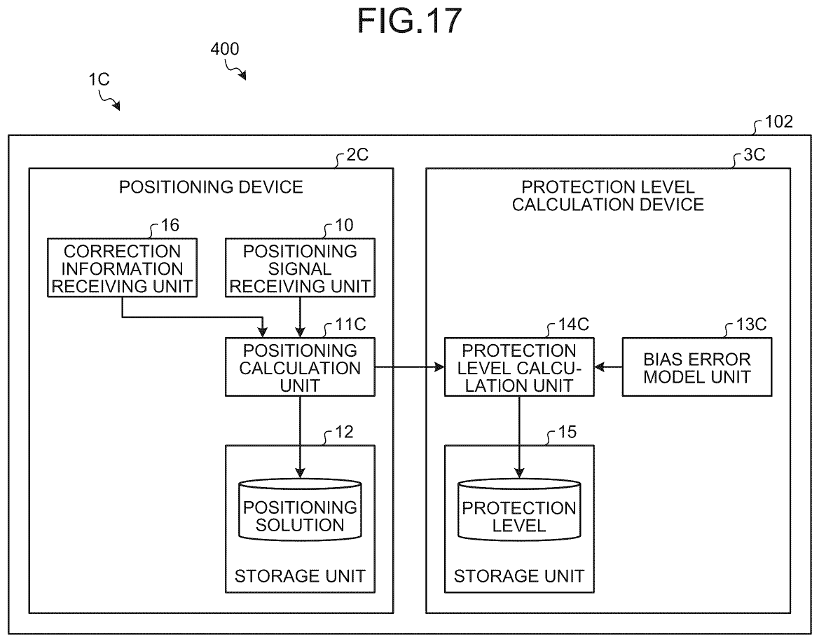

FIG. 17 is a diagram illustrating a configuration example of a protection level calculation system 1C included in a positioning system 400 according to the fourth embodiment. The positioning system 400 according to the fourth embodiment has the same configuration as the positioning system 200 according to second embodiment or the positioning system 300 according to the third embodiment.

The protection level calculation system 1C includes a positioning device 2C that performs positioning, and a protection level calculation device 3C that calculates a protection level. The positioning device 2C includes the positioning signal receiving unit 10 that receives positioning signals transmitted by signal sources that are the satellites 103 or the base stations 104, a positioning calculation unit 11C that performs positioning calculation, the storage unit 12 that stores information, and the correction information receiving unit 16. That is, the positioning device 2C has the same configuration as the positioning device 2A illustrated in FIG. 13. The protection level calculation device 3C includes a bias error model unit 13C that outputs the upper limit and the lower limit of a bias error, a protection level calculation unit 14C that calculates the protection level of a positioning solution, and the storage unit 15 that stores information. That is, the protection level calculation device 3C has the same configuration as the protection level calculation device 3A illustrated in FIG. 13. Thus, the protection level calculation system 1C has the same configuration as the protection level calculation system 1A of the second embodiment. Note that the protection level calculation system 1C may have the same configuration as the protection level calculation system 1B of the third embodiment.

The positioning calculation unit 11C, the bias error model unit 13C, and the protection level calculation unit 14C of the protection level calculation system 1C are implemented by the control circuit 50 illustrated in FIG. 3 or the hardware circuit 55 illustrated in FIG. 4. Part of the positioning signal receiving unit 10 and part of the correction information receiving unit 16 may be a processing circuit.

The bias error model unit 13C handles an integer error assumed to be contained in an integer ambiguity solved for a measurement of each carrier phase, as a bias error assumed to be contained in the measurement of the carrier phase. The measurement of the carrier phase here is a measurement corrected using correction information provided by the positioning augmentation satellite 201 or the reference station 202.

When receiving positioning signals, the positioning signal receiving unit 10 extracts information on the positions of the signal sources and information on the distances between the application 101 and the signal sources as measurements of the pseudo ranges. The positioning signal receiving unit 10 extracts information on the carrier phases as measurements of the carrier phases. The positioning signal receiving unit 10 outputs the measurements of the pseudo ranges and the measurements of the carrier phases to the positioning calculation unit 11C. These measurements output by the positioning signal receiving unit 10 may include Doppler frequency measurements.

The correction information receiving unit 16 receives a signal on correction information transmitted by the positioning augmentation satellite 201 or the reference station 202, and extracts the correction information from the received signal. The correction information receiving unit 16 outputs the correction information to the positioning calculation unit 11C.

Using the correction information, the positioning calculation unit 11C corrects bias errors due to the satellites 103 and bias errors due to the atmosphere, of bias errors contained in the measurements. The positioning calculation unit 11C performs positioning calculation using the corrected measurements to calculate the positioning solution. In addition to the positioning solution, the positioning calculation unit 11C outputs pieces of information on an observation model corresponding to the measurements from the signal sources used in the positioning calculation and weights in the positioning calculation. The positioning solution calculated by the positioning calculation unit 11C may include information on speed, acceleration, or the like.

The positioning device 2C sends the positioning solution, the observation model, and the weights in the positioning calculation output from the positioning calculation unit 11C to the protection level calculation device 3C. The pieces of information on the positioning solution, the observation model, and the weights in the positioning calculation are input to the protection level calculation unit 14C. The upper limit and the lower limit of the bias error output from the bias error model unit 13C are input to the protection level calculation unit 14C. The protection level calculation unit 14C calculates the protection level of the positioning solution, using the observation model and the weights in the positioning calculation, and the upper limit and the lower limit of the bias error. The protection level calculated by the protection level calculation unit 14C is stored in the storage unit 15.

Next, a method of calculating the protection level in the fourth embodiment will be described. The positioning calculation unit 11C corrects the measurements yₚ∈R^{m} of the carrier phases input from the positioning signal receiving unit 10, using the correction information input from the correction information receiving unit 16. Then, the positioning calculation unit 11C calculates the positioning solution using the corrected measurements y_{pc}∈R^{m} of the carrier phases. In addition, the positioning calculation unit 11C performs calculation to resolve an integer uncertain amount contained in the corrected measurement y_{pc,i}∈y_{pc} of the carrier phase, that is, the integer ambiguity of the carrier phase. The ambiguity of the carrier phase is obtained by determining a reference satellite of each satellite system, converting a between-satellite single difference for these reference satellites into an integer, and performing positioning calculation.

An observation equation of the measurement y_{pc,i} of the carrier phase corrected for the bias error due to the satellite 103 and the bias error due to the atmosphere is expressed as in (17) below using a nonlinear observation model h(x).

$$Formula 14$$

$${y}_{{p}_{c} , i} = h ( x ) = ρ ( {pos}^{{sv}_{i}} , pos ) + dt + \frac{c}{f} ▽ + \frac{c}{f} {N}_{ref} + {ε}_{{p}_{c} , i} \qquad ( 17 )$$

Here, ∇ indicates that the amount to which ∇ is applied is the between-satellite single difference for the reference satellite. ρ is a geometric distance and is expressed using the three-dimensional position pos^{svi} of the satellite 103 and the three-dimensional position pos of the positioning terminal 102. dt represents the receiver clock offset of the positioning terminal 102. ∇N_{i,re} with a checkmark thereon represents the ambiguity of the between-satellite single difference converted into an integer. N_{ref} represents the ambiguity of the reference satellite. f represents the frequency of the signal, c represents a high speed, and ε_{pc,i} represents a measurement error. pos, dt, and N_{ref} are included in the state quantities x.

For the reference satellite, that is, the satellite 103 with i=ref, an observation equation of a corrected measurement y_{pc,ref} of the carrier phase is expressed as in (18) below using a nonlinear observation model h(x).

$$Formula 15$$

$${y}_{{p}_{c} , ref} = h ( x ) = ρ ( {pos}^{{sv}_{ref}} , pos ) + dt + \frac{c}{f} {N}_{ref} + {ε}_{{p}_{c} , ref} \qquad ( 18 )$$

Alternatively, when a measurement of the between-satellite single difference is used in the positioning calculation, an observation equation of a corrected measurement ∇y_{pc,i,ref} of the carrier phase is expressed as in (19) below using a nonlinear observation model h(x).

$$Formula 16$$

$$\begin{matrix}▽ {y}_{{p}_{c} , i , ref} = {y}_{{p}_{c} , i} = h ( x ) \\ = ρ ( {pos}^{{sv}_{i}} , pos ) - ρ ( {pos}^{{sv}_{ref}} , pos ) + \frac{c}{f} ▽ + ▽ {ε}_{{p}_{c} , i , ref}\end{matrix} \qquad ( 19 )$$

The positioning calculation unit 11C outputs a coefficient matrix H∈R^{m×n} as an observation model corresponding to the corrected measurements y_{pc}∈R^{m} or ∇y_{pc}∈R^{m} of the carrier phases. Here, m represents the number of dimensions of the measurements used in the positioning calculation. n represents the number of dimensions of the state quantities estimated by the positioning calculation. Therefore, when ∇y_{pc} is used, m in the corrected measurements of the carrier phases is smaller than that in the measurements before between-satellite single differences are taken by the number of reference satellites. The coefficient matrix H∈R^{m×n} is obtained by linearizing a nonlinear observation model h(x)∈R^{m} for the measurements based on state quantities x∈Rⁿ around state quantities x₀∈Rⁿ serving as a reference. Note that the state quantities x∈R^{m} include three-dimensional position information on the positioning terminal 102.

In addition, the positioning calculation unit 11C outputs the error covariance matrix R∈R^{m×m} of observation errors as the weights in the positioning calculation. For example, each diagonal element of the error covariance matrix is σ_{ypi}²+σ_{cpi}² that is the sum of the error variance σ_{ypi}² of each measurement yₚᵢ∈y and the error variance σ_{cpi}² of a correction value cₚᵢ corrected for the bias error due to the satellite 103 and the bias error due to the atmosphere. Here, the correction value cₚᵢ is a correction value calculated from the correction information received by the correction information receiving unit 16.

When the positioning calculation unit 11C uses measurements yrₚ of the carrier phases at the reference station 202 as the correction information, instead of the correction information received from the satellite 103 or the like, each diagonal element of the error covariance matrix is σ_{ypi}²=+σ_{yrpi}² that is the sum of the error variance σ_{ypi}² of each measurement yₚᵢ∈y and the error variance σ_{yrpi}² of a measurement of the carrier phase at the reference station 202 that is a measurement from the same signal source as that of the measurement of the carrier phase.

The error variance σ_{ypi}² can be determined using, for example, a model generated in advance as a function of the signal type or the signal elevation angle. The error variance σ_{cpi}² of a correction value corrected for the bias error due to the satellite 103 and the bias error due to the atmosphere, and the error variance σ_{yrpi}² of a measurement of the carrier phase at the reference station 202 that is a measurement from the same signal source as that of a measurement of the carrier phase, can be determined using a model generated in advance as a function of the signal type or the signal elevation angle. When the values of these error variances are included in the correction information, the values included in the correction information may be used.

The bias error model unit 13C outputs the upper limit b_{amb_max}∈R^{m} of a bias error b_{amb} and the lower limit b_{amb_min}∈R^{m} of the bias error b_{amb} in a measurement of each carrier phase used in the positioning calculation. This bias error is a value obtained by multiplying an integer error assumed to be contained in the ambiguity of the carrier phase of the between-satellite single difference converted into an integer in each measurement used in the positioning calculation by c/f, and varies from measurement to measurement.

The protection level calculation unit 14C calculates the horizontal protection level HPL, using the observation model and the weights in the positioning calculation input from the positioning calculation unit 11C, and the upper limit and the lower limit of the bias error input from the bias error model unit 13C. The horizontal protection level HPL is obtained by solving a nonlinear programming problem shown in (20) below for a bias vector b_{amb}∈R^{m}. The nonlinear programming problem shown in (20) can be solved by a general nonlinear programming solver.

$$Formula 17$$

$$Maximize \qquad ( 20 )$$

$$HPL = \sqrt{{( {M}_{1} {b}_{amb} )}^{2} + {( {M}_{2} {b}_{amb} )}^{2}}$$

$$Subject to$$

$${b}_{amb}^{T} {Gb}_{amb} \leq λ$$

$${b}_{i , amb \_ min} \leq {b}_{i , amb} \leq {b}_{i , amb \_ max} ( i = 1 , … , m )$$

Here, differential coefficients related to the positions that are differential coefficients included in the coefficient matrix H are expressed in an ENU coordinate system that is a local horizontal coordinate system based on a three-dimensional position given by state quantities x₀ serving as a reference.

In the nonlinear programming problem shown in (20), M₁∈R^{1×m} is a row related to a position component in the east-west direction with respect to the reference three-dimensional position in a matrix M=(H^{T}R⁻¹H)⁻¹H^{T}R⁻¹∈R^{n×m}. M₂∈R^{1×m} is a row related to a position component in the north-south direction with respect to the reference three-dimensional position in the matrix M=(H^{T}R⁻¹H)⁻¹H^{T}R⁻¹∈R^{n×m}. A matrix G∈R^{m×m} is expressed as G=(R⁻¹−R⁻¹H(H^{T}R⁻¹H)⁻¹H^{T}R⁻¹). b_{i,amb_min} is an element of b_{amb_min}. b_{i,amb,max} is an element of b_{amb_max}. i is a measurement index.

As with the calculation of the horizontal protection level HPL, the protection level calculation unit 14C calculates the vertical protection level VPL, using the observation model and the weights in the positioning calculation input from the positioning calculation unit 11C, and the upper limit and the lower limit of the bias error input from the bias error model unit 13C. The vertical protection level VPL is obtained by solving a nonlinear programming problem shown in (21) below for a bias vector b_{amb}∈R^{m}. The nonlinear programming problem shown in (21) can be solved by a general nonlinear programming solver.

$$Formula 18$$

$$Maximize \qquad ( 21 )$$

$$VPL = {M}_{3} b$$

$$Subject to$$

$${b}^{T} Gb \leq λ$$

$${b}_{i , amb \_ min} \leq {b}_{i} \leq {b}_{i , amb \_ max} ( i = 1 , … , m )$$

In the nonlinear programming problem shown in (21), M₃∈R^{1×m} is a row related to a position component in the up-and-down direction with respect to the reference three-dimensional position in the matrix M.

The upper limit b_{i,amb_max} and the lower limit b_{i,amb_min} in of the bias error can also be determined by equations (22) and (23) below.

$$Formula 19$$

$${b}_{i , amb\_min} = - \frac{c}{f} \cdot ceil ( K \cdot {σ}_{▽ Ni , ref} ) \qquad ( 22 )$$

$${b}_{i , amb\_max} = \frac{c}{f} \cdot ceil ( K \cdot {σ}_{▽ Ni , ref} ) \qquad ( 23 )$$

That is, the upper limit b_{i,amb_max} and the lower limit b_{i,amb_min} of the bias error are determined by multiplying the standard deviation σ_{∇Ni,ref} of the ambiguity ∇N_{i,ref} of the carrier phase of the between-satellite single difference before converted into an integer, estimated by the positioning calculation unit 11C, by a preset coefficient K. Note that the coefficient K depends on an algorithm to convert the ambiguity of the carrier phase into an integer. The coefficient K is set to reflect a range of values assumed by the algorithm as integer errors.

As described above, the positioning system 400 according to the fourth embodiment uses measurements of the carrier phases in addition to measurements of the pseudo ranges in the calculation of the protection level.

In measurements of the pseudo ranges, errors due to the environment around the positioning terminal 102, such as blocking of signal direct waves by a building or multipath, are dominant. On the other hand, in measurements of the carrier phases, integer errors in the ambiguities solved for the measurements of the carrier phases are dominant as errors. As the positioning calculation proceeds, the ambiguities of the carrier phases are converted into integers. Thus, for the weights of the measurements, those related to the measurements of the carrier phases increase, and those related to the measurements of the pseudo ranges decrease. That is, at an early stage of the positioning calculation, the effect of the bias errors is due to the surrounding environment at a higher rate, while after the positioning calculation proceeds to some extent, the effect is due to the integer errors in the ambiguities of the carrier phases at a higher rate.

The protection level calculation system 1C calculates the protection level of the measurements of the carrier phases, assuming integer errors in the ambiguities of the carrier phases. Consequently, even at a stage where the processing of the positioning calculation has proceeded, and the ambiguities of the carrier phases of the measurements are converted into integers, the protection level calculation system 1C can calculate the protection level effective for determining the validity of the measurements.

Depending on the processing stage of the positioning calculation, bias error factors contain both the signals of the satellites 103 in which integer errors in the ambiguities solved for the measurements of the carrier phases are dominant, and the signals of the satellites 103 in which bias errors due to the surrounding environment contained in the measurements of the pseudo ranges are dominant. In this case, the protection level calculation system 1C may use the functions of the protection level calculation system 1A or 1B described in the second or third embodiment in combination with the functions described in the fourth embodiment. In this case, the protection level calculation unit 14C can calculate the protection level, using an observation model related to, of the corrected measurements y_{c}∈R^{m} used in the positioning calculation, the measurements of the pseudo ranges of the signals of the satellites 103 in which the ambiguities of the carrier phases are not converted into integers, and the measurements of the carrier phases of the signals of the satellites 103 in which the ambiguities of the carrier phases are converted into integers, observation weights, and a bias vector.

As in equations (24) and (25) below, the upper limit bₘₐₓ∈R^{m1+m2} and the lower limit bₘᵢₙ∈R^{m1+m2} of the bias error can reflect bias errors due to the surrounding environment for measurements of the pseudo ranges, and can reflect integer errors in the ambiguities of the carrier phases for measurements of the carrier phases.

$$Formula 20$$

$${b}_{max} = {[ \begin{matrix}{b}_{env \_ max}^{T} & {b}_{amb \_ max}^{T}\end{matrix} ]}^{T} \qquad ( 24 )$$

$${b}_{min} = {[ \begin{matrix}{b}_{env \_ min}^{T} & {b}_{amb \_ min}^{T}\end{matrix} ]}^{T} \qquad ( 25 )$$

The upper limit and the lower limit of the bias error due to the surrounding environment are b_{env_max} and b_{env_min}∈R^{m1}. The upper limit and the lower limit of the bias error due to the ambiguity of the carrier phase are b_{amb_max} and b_{amb_min}∈R^{m2}. Here, m1 represents the number of measurements of the pseudo ranges used in the positioning calculation. m2 represents the number of measurements of the carrier phases in which the ambiguities of the carrier phases are converted into integers, of the carrier phases used in the positioning calculation.

As described above, even when bias error factors contain both the signals of the satellites 103 in which measurements of the carrier phases are dominant, and the signals of the satellites 103 in which measurements of the pseudo ranges are dominant, the positioning system 400 according to the fourth embodiment can calculate the protection level effective for determining the validity of measurements, using the upper limit and the lower limit of the bias error due to the surrounding environment and the ambiguities of the carrier phases.

The configuration described in each of the above embodiments illustrates an example of the subject matter of the present disclosure. The configuration of each embodiment can be combined with another known technique. The respective configurations of the embodiments may be combined as appropriate. The configuration of each embodiment can be partly omitted or changed without departing from the gist of the present disclosure.

### REFERENCE SIGNS LIST

1, 1A, 1B, 1C protection level calculation system; 2, 2A, 2B, 2C positioning device; 3, 3A, 3B, 3C protection level calculation device; 10 positioning signal receiving unit; 11, 11A, 11B, 11C positioning calculation unit; 12, 15 storage unit; 13, 13A, 13B, 13C bias error model unit; 14, 14A, 14B, 14C protection level calculation unit; 16 correction information receiving unit; 17 map information unit; 18 roadside unit; 50 control circuit; 51 input unit; 52 processor; 53 memory; 54 output unit; 55 hardware circuit; 56 processing circuitry; 100, 200, 300, 400 positioning system; 101 application; 102 positioning terminal; 103 satellite; 104 base station; 105 server; 201 positioning augmentation satellite; 202 reference station.

1. A protection level calculation device, comprising:
a bias error model circuitry to output an upper limit and a lower limit of a bias error assumed to be contained in a measurement obtained from a positioning signal; and
a protection level calculation circuitry to calculate a protection level for determining validity of a positioning solution calculated based on the measurement, using the upper limit and the lower limit.

2. The protection level calculation device according to claim 1, wherein the bias error model circuitry determines each of the upper limit and the lower limit, based on an environment model that is a model of an environment around an object of positioning.

3. The protection level calculation device according to claim 2, comprising
a map information circuitry to refer to map information, using the positioning solution or position information on the object of positioning, to determine a class representing a magnitude or an occurrence frequency of the bias error due to environment for the environment around the object of positioning, wherein
the bias error model circuitry determines the upper limit and the lower limit, using the environment model corresponding to the class determined by the map information circuitry.

4. The protection level calculation device according to claim 1, wherein
the protection level calculation circuitry calculates the protection level, further using an upper limit and a lower limit of a bias error assumed to be contained in a measurement of a carrier phase, and
each of the upper limit and the lower limit of the bias error assumed to be contained in the measurement of the carrier phase is a value obtained from a model of an integer error in an ambiguity of the carrier phase.

5. The protection level calculation device according to claim 1, wherein
the protection level calculation circuitry calculates the protection level, further using an upper limit and a lower limit of a bias error assumed to be contained in a measurement of a carrier phase,
each of the upper limit and the lower limit of the bias error assumed to be contained in the measurement that is used to calculate the positioning solution and is the measurement of a pseudo range between a signal source of the positioning signal and an object of positioning is a value obtained from a model of an environment around the object of positioning, and
each of the upper limit and the lower limit of the bias error assumed to be contained in the measurement of the carrier phase is a value obtained from a model of an integer error in an ambiguity of the carrier phase.

6. The protection level calculation device according to claim 2, wherein the environment model is a geometric model obtained from three-dimensional map information.

7. The protection level calculation device according to claim 1, wherein the protection level calculation circuitry calculates the protection level, further using a weight of a prior prediction value of a state quantity that is a weight used in calculation of the positioning solution, and an upper limit and a lower limit of a bias error assumed to be contained in the prior prediction value.

8. The protection level calculation device according to claim 7, wherein the prior prediction value is calculated using a measurement of an inertial sensor.

9. The protection level calculation device according to claim 1, wherein the protection level calculation circuitry calculates the protection level, further using a standard bias error in a correction value for correcting the measurement.

10. A protection level calculation system, comprising:
a positioning calculation circuitry to calculate a positioning solution based on a measurement obtained from a positioning signal;
a bias error model circuitry to output an upper limit and a lower limit of a bias error assumed to be contained in the measurement; and
a protection level calculation circuitry to calculate a protection level for determining validity of the positioning solution, using the upper limit and the lower limit.

11. The protection level calculation system according to claim 10, wherein
the positioning calculation circuitry is included in a first device, and
the bias error model circuitry and the protection level calculation circuitry are included in a second device that can communicate with the first device.

12. A positioning system, comprising the protection level calculation system according to claim 10.

13. A protection level calculation method performed by a protection level calculation device, the method comprising:
outputting, by a bias error model circuitry, an upper limit and a lower limit of a bias error assumed to be contained in a measurement obtained from a positioning signal; and
calculating, by a protection level calculation circuitry, a protection level for determining validity of a positioning solution calculated based on the measurement, using the upper limit and the lower limit.

14. The protection level calculation device according to claim 5, wherein the environment model is a geometric model obtained from three-dimensional map information.
